(19) United States
(12) Patent Application Publication
(10) Pub. No.: US 2018/0054699 A1
(43) Pub. Date: Feb. 22, 2018

(54) SYSTEM AND METHODS TO SUPPORT A CLUSTER OF POSITIONING BEACONS

(71) Applicant: QUALCOMM Incorporated, San Diego, CA (US)

(72) Inventors: Stephen William Edge, Escondido, CA (US); Luis Lopes, Swindon (GB); Sven Fischer, Nuremberg (DE)

(21) Appl. No.: 15/591,006

(22) Filed: May 9, 2017

Related U.S. Application Data
(60) Provisional application No. 62/377,669, filed on Aug. 21, 2016.
(60) Provisional application No. 62/400,073, filed on Sep. 26, 2016.

(51) Int. Cl. H04W 4/02; H04L 5/00; H04W 40/24

(52) U.S. Cl. CPC H04W 4/02; H04W 88/08; H04W 40/244; H04L 5/0048

(57) ABSTRACT

Methods and techniques are described for economically supporting a cluster of transmission points (TPs) that serve as positioning only beacons in a wireless network. A TP may broadcast a positioning reference signal (PRS) for positioning of a user equipment (UE) using the 3GPP OTDOA method for LTE wireless access. TPs are controlled by a TP Controller (TPC) that may function as an evolved NodeB (eNB) or Home eNB. A TPC may configure (or retrieve) PRS parameters in (or from) a controlled TP, may provide an accurate time reference to the TP and may be connected to the TP using a LAN or WLAN. A location server such as an E-SMLC may retrieve information for TPs, such as PRS parameters, TP location, and TP identity, from a controlling TPC, e.g. using the LPPa protocol. An E-SMLC may access a TPC via an MME to which the TPC may be connected.

### CROSS REFERENCE TO RELATED APPLICATIONS

This application claims the benefit of and priority to: U.S. Provisional Patent Application No. 62/377,669 entitled “SYSTEM AND METHODS TO SUPPORT A CLUSTER OF POSITIONING BEACONS,” filed Aug. 21, 2016, and U.S. Provisional Patent Application No. 62/400,073 entitled “SYSTEM AND METHODS TO SUPPORT A CLUSTER OF POSITIONING BEACONS,” filed Sep. 26, 2016. The above-identified applications are assigned to the assignee hereof and incorporated by reference in their entireties.

### FIELD

The subject matter disclosed herein relates to location determination and more specifically, to techniques to support positioning beacons or transmission points in Terrestrial Beacon Systems (TBS).

### BACKGROUND

It is often desirable to know the location of a mobile device such as a cellular phone. For example, a location services (LCS) client may desire to know the location of a mobile device in the case of an emergency services call from the mobile device or to provide some service to the user of the mobile device such as navigation assistance or direction finding. The terms “location” and “position” are synonymous and are used interchangeably herein.

In Observed Time Difference of Arrival (OTDOA) based positioning, a mobile device may measure time differences between signals received from different pairs of base stations. Because positions of the base stations can be known, the observed time differences may be used to calculate the location of the mobile device. To further help location determination, Positioning Reference Signals (PRS) may be provided by a base station (BS) in order to improve OTDOA positioning performance. The measured time difference of arrival of the PRS from a reference cell (e.g. the serving cell) and a neighboring cell is known as a Reference Signal Time Difference (RSTD). Using the RSTD measurements for two (or more usually three) or more neighbor cells, the known absolute or relative transmission timing of each cell, and the known position(s) of BS physical transmitting antennas for the reference and neighboring cells, the position of the mobile device may be calculated.

Positioning beacons or transmission points (hereinafter referred to as “TPs”) are sometimes used to provide improved location accuracy in areas with a low density of visible base stations. The positioning beacons can provide additional downlink PRS signals to be measured by a mobile device but may not provide any communication support—e.g. may not support uplink signal reception from a mobile device or other communications services normally associated with a BS.

In conventional systems, the improved position accuracy provided by positioning beacons may be offset by the additional cost of the positioning beacons and additional network resources that may be used during positioning beacon operation. For example, backhaul signaling connections and other operations support for positioning beacons in conventional systems may require additional network resources and increase overhead. Thus, systems and methods to lower the cost and improve the configuration and operation of positioning beacons may facilitate deployment of positioning beacons and improve positioning accuracy.

### SUMMARY

In some embodiments, a method on a Transmission Point Controller (TPC) to facilitate User Equipment (UE) location determination may comprise: exchanging a first signaling information with a Positioning Reference Signal Transmission Point (PRS TP) broadcasting a downlink (DL) positioning reference signal (PRS) to the UE, wherein the PRS TP is controlled by the TPC and the broadcasting is based at least in part on the first signaling information; and exchanging a second signaling information with a location server, wherein the second signaling information comprises at least a portion of the first signaling information. PRS TPs are TPs that refrain from broadcasting information to the UE indicating support for uplink signals from the UE. In some embodiments, the TPC may be communicatively coupled to the PRS TP using a local area network (LAN) or a wireless LAN (WLAN).

In some embodiments, exchanging the first signaling information may comprise sending the first signaling information to the PRS TP, wherein the first signaling information comprises a common time reference. In some embodiments, the common time reference may be determined based on input from a GPS receiver or a GNSS receiver (e.g. SPS receiver 740) coupled to the TPC 140, wherein the common time reference is a time reference for one of: the Global Positioning System (GPS), or a Coordinated Universal Time (UTC), or a Global Navigation Satellite System (GNSS). In some embodiments, the DL PRS may be for the 3GPP LTE radio access type.

In some embodiments, the first signaling information and the second signaling information may each comprise PRS configuration parameters for the PRS TP, an identity of the PRS TP, a location of the PRS TP, or some combination thereof. In some embodiments, the method may further comprise: receiving third signaling information from an Operations and Maintenance (O&M) server communicatively coupled to the TPC; and exchanging the first signaling information with the PRS TP may comprise sending the first signaling information to the PRS TP, wherein the first signaling information comprises a portion of the third signaling information.

In some embodiments, the DL PRS may be for the 3rd Generation Partnership Project (3GPP) Long Term Evolution radio access type. In embodiments where the DL PRS is for 3GPP LTE radio access type, the second signaling information may be exchanged using the 3GPP LTE Positioning Protocol A (LPPa). In embodiments where the DL PRS is for 3GPP LTE radio access type, the location server may be an Enhanced Serving Mobile Location Center (E-SMLC) or a Secure User Plane Location (SUPL) Location Platform (SLP). In embodiments where the DL PRS is for the 3GPP LTE radio access type, the TPC may include functionality for a 3GPP evolved NodeB (eNB) or a 3GPP Home eNB. In embodiments where the DL PRS is for the 3GPP LTE radio access type, the TPC may be communicatively coupled to a Mobility Management Entity (MME) using a 3GPP S1 interface or a subset of a 3GPP S1 interface.

In another aspect, a Transmission Point Controller (TPC) to facilitate User Equipment (UE) location determination may comprise: a memory and a processor coupled to the memory. The processor may be configured to: perform the exchange of a first signaling information with a Positioning Reference Signal Transmission Point (PRS TP) broadcasting a downlink (DL) positioning reference signal (PRS) to the UE, wherein the PRS TP is controlled by the TPC and the broadcasting is based at least in part on the first signaling information; and perform the exchange of a second signaling information with a location server, wherein the second signaling information comprises at least a portion of the first signaling information. PRS TPs are TPs that refrain from broadcasting information to the UE indicating support for uplink signals from the UE.

In a further aspect, a Transmission Point Controller (TPC) to facilitate User Equipment (UE) location determination may comprise: means for exchanging a first signaling information with a Positioning Reference Signal Transmission Point (PRS TP) broadcasting a downlink (DL) positioning reference signal (PRS) to the UE, wherein the PRS TP is controlled by the TPC and the broadcasting is based at least in part on the first signaling information; and means for exchanging a second signaling information with a location server, wherein the second signaling information comprises at least a portion of the first signaling information. PRS TPs are TPs that refrain from broadcasting information to the UE indicating support for uplink signals from the UE.

In some embodiments, a non-transitory computer-readable medium for a Transmission Point Controller (TPC) may comprise executable instructions to facilitate location determination for a User Equipment (UE), wherein the executable instructions may configure a processor to: exchange a first signaling information with a Positioning Reference Signal Transmission Point (PRS TP) broadcasting a downlink (DL) positioning reference signal (PRS) to the UE, wherein the PRS TP is controlled by the TPC and the broadcasting is based at least in part on the first signaling information; and exchange a second signaling information with a location server, wherein the second signaling information comprises at least a portion of the first signaling information. PRS TPs are TPs that refrain from broadcasting information to the UE indicating support for uplink signals from the UE.

Disclosed embodiments pertain to a method on a Transmission Point (TP) to facilitate location determination for a User Equipment (UE), the method comprising: exchanging a signaling information with a Transmission Point Controller (TPC); broadcasting a downlink (DL) positioning reference signal (PRS) to the UE, wherein the broadcast of the DL PRS is based, at least in part, on the signaling information; and refraining from broadcasting information to the UE indicating support for uplink signals from the UE. In some embodiments, the DL PRS may be for the 3^{rd} Generation Partnership Project (3GPP) Long Term Evolution radio access type. In embodiments where the DL PRS is for the 3GPP LTE radio access type, the TPC may include functionality for a 3GPP evolved NodeB (eNB) or a 3GPP Home eNB.

In some embodiments, the signaling information may comprise PRS configuration parameters for the TP, an identity of the TP, a location of the TP, or a combination thereof. In some embodiments, exchanging the signaling information with the TPC may comprise receiving the signaling information from the TPC, wherein the signaling information comprises a common time reference. In some embodiments, the common time reference may be a time reference for one of: a Global Positioning System (GPS), or a Coordinated Universal Time (UTC), or a Global Navigation Satellite System (GNSS), and the method may further comprise: synchronizing the broadcast of the DL PRS to the common time reference.

In another aspect, a TP to facilitate location determination for a User Equipment (UE) may comprise a memory, a transceiver, and a processor coupled to the memory and the transceiver, wherein the processor is configured to: perform, via the transceiver, the exchange of signaling information with a Transmission Point Controller (TPC); initiate broadcast, via the transceiver, of a downlink (DL) positioning reference signal (PRS) to the UE, wherein the broadcast of the DL PRS is based, at least in part, on the signaling information; and configure the transceiver to refrain from broadcasting information to the UE indicating support for uplink signals from the UE.

In a further aspect, a TP to facilitate location determination for a User Equipment (UE) may comprise: means for exchanging a signaling information with a Transmission Point Controller (TPC); means for broadcasting a downlink (DL) positioning reference signal (PRS) to the UE, wherein the broadcast of the DL PRS is based, at least in part, on the signaling information, wherein means for broadcasting refrains from broadcasting information to the UE indicating support for uplink signals from the UE.

In some embodiments, a non-transitory computer-readable medium may comprise executable instructions to facilitate location determination for a User Equipment (UE), wherein the executable instructions may configure a processor on a TP to: exchange a signaling information with a Transmission Point Controller (TPC); broadcast a downlink (DL) positioning reference signal (PRS) to the UE, wherein the broadcast of the DL PRS is based, at least in part, on the signaling information; and refrain from broadcasting information to the UE indicating support for uplink signals from the UE.

In some embodiments, a method on a location server to determine a location of a user equipment (UE) may comprise: exchanging a first signaling information with a Transmission Point Controller (TPC), wherein the TPC controls at least one Positioning Reference Signal Transmission Point (PRS TP), the at least one PRS TP broadcasting a downlink (DL) Positioning Reference Signal (PRS) to the UE, the broadcast of the DL PRS based at least in part on the first signaling information; sending a second signaling information to the UE, the second signaling information comprising a portion of the first signaling information; receiving a third signaling information from the UE, the third signaling information based on the second signaling information; and determining a location of the UE based, at least in part, on the first signaling information and the third signaling information. PRS TPs are TPs that refrain from broadcasting information to the UE indicating support for uplink signals from the UE.

In some embodiments, the first signaling information may comprise PRS configuration parameters for the at least one TP, an identity of the at least one TP, a location of the at least one TP, or some combination thereof. In some embodiments, exchanging a first signaling information with a Transmission Point Controller (TPC) may comprise receiving the first signaling information from the TPC.

In some embodiments, the DL PRS may be for the 3^{rd} Generation Partnership Project (3GPP) Long Term Evolution radio access type. Further, the first signaling information may be exchanged using the 3GPP LTE Positioning Protocol A (LPPa). In embodiments, where the DL PRS may be for the 3GPP LTE radio access type, the location server is an enhanced serving mobile location center (E-SMLC) or a Secure User Plane Location (SUPL) Location Platform (SLP). In embodiments, where the DL PRS may be for the 3GPP LTE radio access type, the TPC may include functionality for a 3GPP evolved NodeB (eNB) or a 3GPP Home eNB.

In embodiments, where the DL PRS may be for the 3GPP LTE radio access type, the second signaling information may be sent and the third signaling information may be received using the 3GPP LTE Positioning Protocol (LPP). Further, the second signaling information may comprise an LPP Provide Assistance Data message, and the third signaling information may comprise an LPP Provide Location Information message, and the location of the UE may be determined based on the 3GPP observed time difference of arrival (OTDOA) position method.

In another aspect, a location server to determine a location of a user equipment (UE) may comprise: a memory, and a processor coupled to the memory, wherein the processor is configured to: exchange a first signaling information with a Transmission Point Controller (TPC) controlling at least one Positioning Reference Signal Transmission Point (PRS TP), which broadcasts a downlink (DL) Positioning Reference Signal (PRS) to the UE, wherein the broadcast of the DL PRS is based at least in part on the first signaling information; send a second signaling information to the UE, the second signaling information comprising a portion of the first signaling information; receive a third signaling information from the UE, the third signaling information based on the second signaling information; and determine a location of the UE based, at least in part, on the first signaling information and the third signaling information. PRS TPs are TPs that refrain from broadcasting information to the UE indicating support for uplink signals from the UE.

In a further aspect, a location server to determine a location of a user equipment (UE) may comprise: means for exchanging a first signaling information with a Transmission Point Controller (TPC) controlling at least one Positioning Reference Signal Transmission Point (PRS TP), which broadcasts a downlink (DL) Positioning Reference Signal (PRS) to the UE, the broadcast of the DL PRS based at least in part on the first signaling information; means for sending a second signaling information to the UE, the second signaling information comprising a portion of the first signaling information; means for receiving a third signaling information from the UE, the third signaling information based on the second signaling information; and means for determining a location of the UE based, at least in part, on the first signaling information and the third signaling information. PRS TPs are TPs that refrain from broadcasting information to the UE indicating support for uplink signals from the UE.

In some embodiments, a non-transitory computer-readable medium may comprise executable instructions to determine a location of a user equipment (UE) wherein the executable instructions may configure a processor to: exchange a first signaling information with a Transmission Point Controller (TPC) controlling at least one Positioning Reference Signal Transmission Point (PRS TP), which broadcasts a downlink (DL) Positioning Reference Signal (PRS) to the UE, the broadcast of the DL PRS based at least in part on the first signaling information; send a second signaling information to the UE, the second signaling information comprising a portion of the first signaling information; receive a third signaling information from the UE, the third signaling information based on the second signaling information; and determine a location of the UE based, at least in part, on the first signaling information and the third signaling information. PRS TPs are TPs that refrain from broadcasting information to the UE indicating support for uplink signals from the UE.

The methods disclosed may be performed by one or more of servers including location servers, mobile devices, etc. using LPP, LPPe, LPPa, or other protocols. Embodiments disclosed also relate to software, firmware, and program instructions created, stored, accessed, read, or modified by processors using non-transitory computer readable media or computer readable memory.

### BRIEF DESCRIPTION OF THE DRAWINGS

FIG. 1 shows an architecture of an exemplary system with TPs capable of providing Location Services to UEs.

FIG. 2A shows the structure of an exemplary LTE subframe sequence with PRS positioning occasions.

FIG. 2B provides a further illustration of an exemplary LTE subframe sequence with PRS positioning occasions.

FIG. 3 shows a signaling flow diagram for positioning of a UE according to some disclosed embodiments.

FIGS. 4, 5, 6A, and 6B show flowcharts illustrating an exemplary method of positioning a UE according to some disclosed embodiments.

FIG. 7 shows a schematic block diagram illustrating certain exemplary features of a TP controller.

FIG. 8 shows a schematic block diagram illustrating a positioning beacon or TP.

FIG. 9 shows a schematic block diagram illustrating a location server.

Like numbered entities in different figures may correspond to one another. Different instances of a common type of entity may be indicated by appending a label for the common entity with an additional label. For example, different instances of a TP 110 may be labeled 110-1, 110-2 etc. When referring to a common entity without an extra appended label (e.g. TP 110), any instance of the common entity can be applicable.

### DETAILED DESCRIPTION

The terms “device”, “mobile device”, “user equipment” (UE) and “target” are used interchangeably herein and may refer to a device such as a cellular or other wireless communication device, personal communication system (PCS) device, personal navigation device (PND), Personal Information Manager (PIM), Personal Digital Assistant (PDA), laptop, cell phone, smartphone, tablet, tracking device or other suitable mobile device which is capable of receiving wireless communication and/or navigation signals. The terms are also intended to include devices which communicate with a personal navigation device (PND), such as by short-range wireless, infrared, wireline connection, or other connection—regardless of whether satellite signal reception, assistance data reception, and/or position-related processing occurs at the device or at the PND. The term “communicate,” “communicating,” or “communication” as used herein refers to sending/transmission, reception, or relaying of signals by an entity; or some combination of sending/transmission, reception, or relaying. The term “location” (also referred to as a “position”) as used herein may refer to a geodetic location that may comprise coordinates (e.g. latitude, longitude, and possibly altitude) and optionally an expected error or uncertainty for the location. A geodetic location may be absolute (e.g. comprise a latitude and longitude) or may be relative to some other known absolute location. A location may also be civic and comprise a place name, street address or other verbal description or definition.

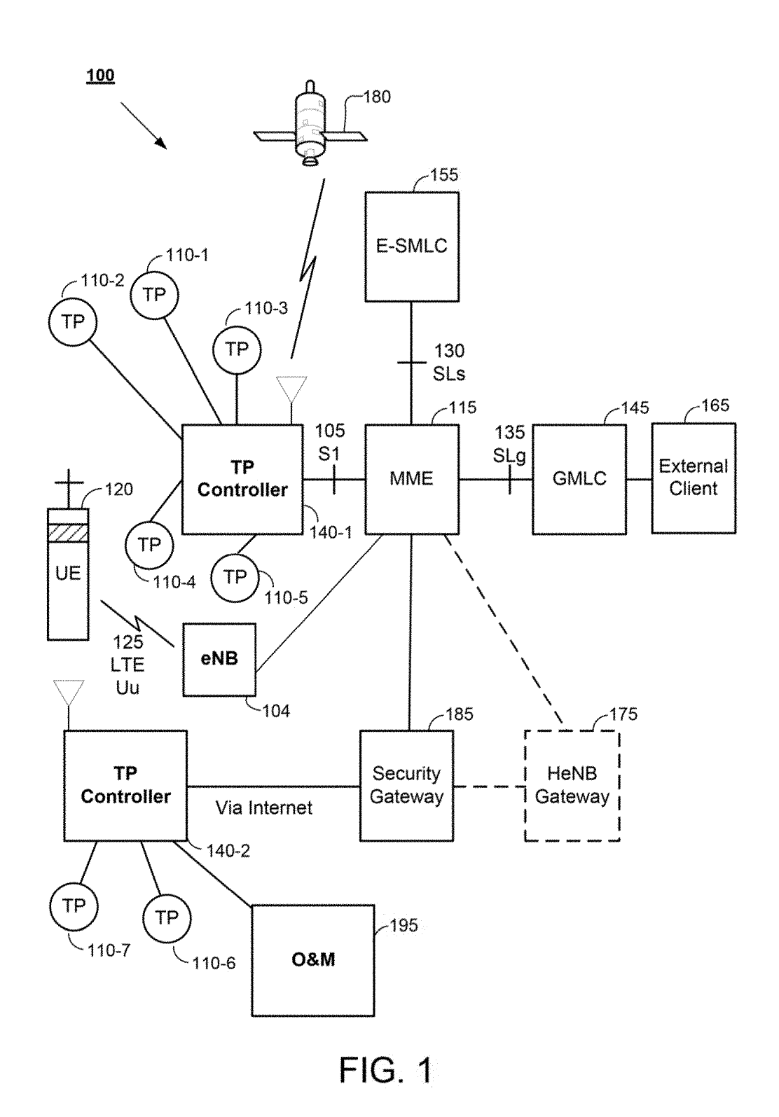

FIG. 1 shows an architecture of an exemplary system 100 with TPs 110 capable of providing Location Services to a UE 120 including the transfer of location assistance data or location information. System 100 may support the transfer of location assistance data and/or location information, using messages such as Long Term Evolution (LTE) Positioning Protocol (LPP) or LPP extensions (LPPe) messages between UE 120 and a Location Server (LS) such as an Enhanced Serving Mobile Location Center (E-SMLC) 155 or another network entity. Further, the LPP A protocol (LPPa) may be used for communication between an LS or E-SMLC 155 and one or more TPCs 140. In some embodiments, system 100 may include a Terrestrial Beacon System (TBS) (e.g. a network of ground-based transmitters or TPs broadcasting signals for geo-spatial positioning) with wide-area or regional coverage. For example, a TBS may include a number of TPs 110 that each transmit a Positioning Reference Signal (PRS) to support location determination for UEs 120.

The LTE radio access type is described in documents available from an organization known as the 3rd Generation Partnership Project (3GPP). In some embodiments, system 100 may form part of, comprise, or contain an Evolved Packet System (EPS), which may comprise an evolved UMTS Terrestrial Radio Access Network (E-UTRAN) and an Evolved Packet Core (EPC). LPP is well-known and described in various publicly available technical specifications from 3GPP (e.g. 3GPP Technical Specification (TS) 36.355). LPPe has been defined by the Open Mobile Alliance (OMA) (e.g. in OMA TS OMA-TS-LPPe-V1_0) and may be used in combination with LPP such that an LPP message may contain an embedded LPPe message in a combined LPPILPPe message. LPPa is described in the publicly available 3GPP TS 36.455 document. In general, a positioning protocol such as LPP and/or LPPe may be used by an LS to coordinate and control position determination for a UE such as UE 120. The positioning protocol may define: (a) positioning related procedures that may be executed by the LS and/or UE; and/or (b) communication or signaling exchanged between the UE and LS related to positioning of the UE. In the case of LPPa, the protocol may be used between an LS (e.g. E-SMLC 155) and a BS (e.g. eNB 104) to enable the LS to request and receive configuration information for the BS (e.g. details of PRS signals transmitted by the BS) and positioning measurements made by the BS of a UE.

In FIG. 1, one or more of the blocks shown may correspond to logical entities. The logical entities shown in FIG. 1 may be physically separate, or, one or more of the logical entities may be included in a single physical server or device. The transfer of the location information may occur at a rate appropriate to both UE 120 and the LS or other entity. The logical entities and blocks shown in FIG. 1 are merely exemplary and the functions associated with the logical entities/blocks may be split or combined in various ways in a manner consistent with disclosed embodiments.

System 100 includes an evolved NodeB 104 (also referred to as an eNodeB or eNB), a Mobility Management Entity (MME) 115, a Gateway Mobile Location Center (GMLC) 145, an Enhanced Serving Mobile Location Center (E-SMLC) 155, a Security Gateway 185, and a Home eNB (HeNB) Gateway 175. The eNB 104, MME 115, E-SMLC 155, Security Gateway 185 and Home eNB (HeNB) Gateway 175 may be part of a serving network for UE 120, which may also be a home network for UE 120, and may be referred to as an Evolved Packet System (EPS).

The eNB 104 may be a serving eNB for UE 120 and may function as a base station (BS) supporting LTE wireless access by UE 120 including supporting the transfer of control signaling, voice and/or data between UE 120 and entities such as one or more of MME 115, E-SMLC 155, GMLC 145, and External Client 165. In some embodiments, eNB 104 may also support transfer of control signaling, voice and/or data between UE 120 and other entities not shown in FIG. 1 such as a Secure User Plane Location (SUPL) Location Platform (SLP) or other UEs.

The MME 115 may be the serving MME for UE 120 and may support attachment and network connection of UE 120, mobility of UE 120 (e.g. via handover between different network cells) as well as establishing and releasing data and voice bearers on behalf of UE 120. GMLC 145 may provide access on behalf of an external client (e.g. External Client 165) to the location of UE 120. The External Client 165 may be a web server or remote application that may have some association with UE 120 (e.g. may be accessed by a user of UE 120) or may be a server, application or computer system providing a location service to some other user or users which may include obtaining and providing the location of UE 120 (e.g. to enable a service such as friend or relative finder, asset tracking or child or pet location).

The E-SMLC 155 may be an LS that supports a control plane location solution enabling a location of a UE (e.g. UE 120) with LTE radio access to be obtained. With a control plane (CP) location solution, the signaling used to initiate positioning of a UE 120 and the signaling related to the positioning of UE 120 occur over interfaces of a cellular network and using protocols that support signaling (as opposed to data or voice transfer). In CP positioning, the location server may include or take the form of an E-SMLC such as E-SMLC 155. The architecture illustrated in FIG. 1 may support a control plane location solution.

With a User Plane (UP) location solution, such as the Secure User Plane Location (SUPL) location solution defined by the Open Mobile Alliance (OMA), signaling to initiate and perform positioning of a UE (e.g. UE 120) may be transferred using interfaces and protocols that support transfer of data (and possibly voice and other media). With the SUPL UP location solution, the location server may include or take the form of a SUPL Location Platform (SLP) such as a Home SLP (H-SLP) or emergency SLP (E-SLP). For example, the SLP (not shown in FIG. 1) may be connected to or accessed via the Internet and may communicate with UE 120 via a BS (e.g. eNB 104) and one or more other entities such as a Serving Gateway and Packet Data Network Gateway (not shown in FIG. 1).

The Security Gateway 185 and HeNB Gateway 175 may be used to support connection of small cells and/or HeNBs (not shown in FIG. 1). The small cells and/or HeNBs are small base stations that support LTE radio access by UEs (e.g. UE 120) over a small area (e.g. 100 to 200 meters or less from one side to another) and may connect to the Security Gateway 185 via the Internet and/or via an Internet Service Provider. The Security Gateway 185 may help authenticate the small cells and/or HeNBs and may enable secure communication between the small cells and/or HeNBs and other network entities such as MME 115. The HeNB Gateway 175 may be combined with the Security Gateway 185 or may be separate and may perform protocol relaying and conversion in order to allow small cells and/or HeNBs connected to Security Gateway 185 to communicate with other entities such as MME 115.

System 100 also includes one or more Space Vehicles (SVs) 180, which may be part of a Satellite Positioning System (SPS) such as a Global Navigation Satellite System (GNSS). Examples of a GNSS include the Global Positioning System (GPS), Galileo, GLONASS, and Beidou.

For simplicity, only one UE 120, two TP controllers (TPCs) 140, one eNB 104 and seven TPs 110 are shown in FIG. 1. In general, system 100 may comprise several or many UEs 120, multiple cells served by multiple TPCs 140 and/or multiple eNBs 104, multiple TPs 110, and additional logical and/or physical entities.

As shown in FIG. 1, UE 120 may be capable of receiving wireless communication from TPCs 140, TPs 110 and/or eNB 104 over an LTE-Uu radio interface 125. LTE-Uu radio interface 125 may facilitate communication between UE 120 and a TPC 140, between UE 120 and a TP 110 and between UE 120 and eNB 104.

A TPC 140 may control a number of TPs 110 (e.g. up to 4096 TPs 110 in some implementations) that transmit downlink radio signals (e.g. PRS signals) to assist positioning of UE 120. As referred to herein, a TP 110 is considered to act as a positioning beacon and to transmit downlink signals (e.g. PRS signals) to assist positioning of UE 120. A TP 110 may be physically separate from a TPC 140 and is then referred to herein as an “external TP 110.” For example, each of TPs 110-1 to 110-7 in system 100 is considered to be an external TP. An external TP 110 may obtain electrical power from any convenient local source such as a building it is attached to or located within, a street light (e.g. if attached to a street light pole) or a nearby local power line and/or may have its own power source such as a solar panel and battery. A TP 110 may also be part of a TPC 140. For example, a TPC 140 may include a TP 110 and transmit downlink radio signals (e.g. function as an eNB/TPC 140 as described below). A TP 110, which is part of TPC 140, is referred to herein as an “internal TP 110.”

A TP 110 (e.g. an external TP 110 that functions as a remote radio head or an internal TP 110) may support reception of uplink signals from UE 120 and assist UE 120 to communicate with other entities such as MME 115 or E-SMLC 155. However, in some embodiments, a TP 110 may not support uplink functionality such as the reception of uplink signals from UE 120 or assisting UE 120 to communicate with other entities such as MME 115 or E-SMLC 155. A TP 110 that does not support uplink functionality may be referred to as a terrestrial beacon system (TBS) beacon, a TBS TP, a PRS TP, a positioning beacon, a positioning only beacon, a positioning only PRS beacon, a PRS beacon, an eNB beacon, a standalone eNB beacon, or a RAN beacon. Thus, a PRS TP may transmit downlink radio signals (e.g. PRS signals) to UEs but may refrain from broadcasting information to the UE indicating support for uplink signals from the UE.

In system 100, TPs 110-1 to 110-7 are all considered to be PRS TPs (i.e. the TPs do not support uplink functionality). A TP 110 that does not support reception of uplink signals from UE 120 may refrain from broadcasting information to the UE 120 indicating such support. For example, the TP 110 may refrain from broadcasting one or more of a master information block (MIB), a system information block 1 (SIB1) or a system information block 2 (SIB2) (e.g. as defined in 3GPP TS 36.331 entitled “Radio Resource Control (RRC); Protocol specification,”) for normal support of uplink LTE signals from a UE 120 by an eNB or HeNB.

In some embodiments, a TPC 140 may be connected to, and may communicate with, one or more external TPs 110 that are controlled by the TPC 140 using a Local Area Network (LAN), a Wireless LAN (WLAN), or microwave links. For example, as shown in FIG. 1, TPC 140-1 is connected to external TPs 110-1, 110-2, 110-3, 110-4, and 110-5, while TPC 140-2 is connected to external TPs 110-6 and 110-7. A LAN may be an Institute of Electrical and Electronics Engineers (IEEE) 802.3x network, for example. A WLAN may be an IEEE 802.11x network. Signaling between a TPC 140 and an external TP 110 may be used by TPC 140 to configure or reconfigure a TP 110, provide a common timing reference to a TP 110, and/or to monitor TP 110 operation. For example, TPs 110 may act as PRS TPs and may transmit PRS after being appropriately configured by a TPC 140.

In some embodiments, a TPC 140 may function as both a TPC and as an eNB or HeNB by including functions of an eNB or HeNB, respectively. A TPC 140 that functions as both an eNB and TPC is referred to herein as an eNB/TPC 140 and may also be referred to as an eNB or enhanced eNB. Similarly, a TPC 140 that functions as both an HeNB and TPC is referred to herein as an HeNB/TPC 140 and may be referred to as an HeNB or enhanced HeNB. The term (H)eNB is used herein to refer to an eNB or an HeNB, and the term “(H)eNB/TPC” refers to a TPC that includes functionality for an eNB or HeNB. An (H)eNB/TPC 140 supports the normal functions defined by 3GPP for an (H)eNB such as supporting LTE wireless access and communication on behalf of one or more UEs 120 as well as functioning as a TPC. An (H)eNB/TPC 140 may support normal two way LTE radio access by UE 120 in one or more LTE cells supported by the (H)eNB/TPC 140. An (H)eNB/TPC 140 may also support downlink PRS transmission from one or more external TPs 110 controlled by the (H)eNBTPC 140 such as TPs 110-1 to 110-5 in the case of TPC 140-1 (when TPC 140-1 is an eNB/TPC) or TPs 110-6 and 110-7 in the case of TPC 140-2 (when TPC 140-2 is an HeNB/TPC).

Each of the cells supported by an (H)eNB/TPC 140 may correspond to a distinct internal TP 110 that is functionally part of the (H)eNB/TPC 140 as described earlier. A internal TP 110 may support one cell for an (H)eNB/TPC 140 and may share an antenna or multiple antenna elements for the (H)eNB/TPC 140 with other internal TPs 110 that are part of the same (H)eNB/TPC 140 and that support other cells for the (H)eNB/TPC 140 (e.g. in the case of an eNB/TPC 140 that supports a number of separate cell sectors). The coverage area(s) of the cell(s) (e.g. for internal TP(s) 110) supported by an (H)eNB/TPC 140 and the coverage area(s) for the external TP(s) 110 controlled by the (H)eNB/TPC 140 may or may not overlap. For example, fully overlapping or partially overlapping coverage areas may be useful to increase the number of TPs 110 and eNBs 104 visible to UE 120 at any one location, whereas non-overlapping or partially overlapping coverage areas may be useful to extend the overall coverage area of the (H)eNB/TPC 140 with regards to support of positioning of a UE 120. It is to be understood that a TPC 140 not designated herein as an (H)eNB/TPC 140 may or may not contain (H)eNB functionality.

The Functions of a TPC 140 can include: (i) communicating with one or more external TPs 110 (e.g. via a LAN or WLAN); (ii) configuring and/or reconfiguring downlink (DL) signaling information in external TPs 110 (e.g. information related to transmission of PRS signals); (iii) activating and deactivating external TPs 110; (iv) communicating with an LS (e.g. an E-SMLC 155) using, for example, LPPa: to allow the LS to request and receive configuration information for internal and/or external TPs 110 controlled by the TPC 140, or to provide configuration information for internal and/or external TPs to the TPC 140; (v) communicating with an Operations and Maintenance (O&M) system or server to receive configuration information for TPs 110; (vi) providing timing information to external TPs 110 (e.g. GPS time information obtained using a GPS receiver associated with or co-located with the TPC 140); and/or (vii) requesting and obtaining from external TPs 110 downlink (DL) signaling information for TPs 110 (e.g. information related to transmission of PRS signals) and/or other information for the external TPs 110 (e.g. location coordinates of an antenna for a TP 110). A TPC 140 that interacts with an external TP 110 as just described (e.g. to configure PRS information for the TP 110) or that has an internal TP 110 may be referred to as a controlling TPC 140 or serving TPC 140 for the external or internal TP 110, respectively, and the TP 110 (whether internal or external) may be referred to as a TP 110 that is controlled by, configured by or associated with the TPC 140. An (H)eNB/TPC 140 that interacts with an external TP 110 as just described (e.g. to configure PRS information for the TP 110) or that has an internal TP 110 may be referred to as a controlling (H)eNB or serving (H)eNB for the external or internal TP 110, respectively.

The use of a TPC 140 or (H)eNB/TPC 140 to control (or serve) a plurality of TPs 110 (e.g. up to 256 or 4096 TPs 110) may reduce the complexity of external TPs 110 and/or the cost of deploying external TPs 110. For example, an external TP 110 may support communication with one TPC 140 or one (H)eNB/TPC 140 (e.g. using a LAN or WLAN). This may enable an external TP 110 to operate without an Internet connection and a public IP address, without supporting a GPS or other GNSS receiver, and/or without other standalone capability to autonomously obtain an accurate common time reference, which may reduce external TP 110 cost and complexity. In addition, when a TPC 140 or (H)eNB/TPC 140 provides an accurate common time reference (e.g. GPS time or other GNSS time) to an external TP 110, the external TP 110 may be enabled to operate at a location (e.g. a basement or deep inside a building) where common time signals (e.g. GPS signals) cannot be received or cannot be accurately received (e.g. without an impairment to an ability to transmit synchronized signals such as synchronized PRS signals). In some embodiments, TPs 110 associated with a TPC 140 may serve (e.g. transmit DL PRS signals that can be received and measured in) multiple cells, a single cell or some portions of a cell.

A TPC 140 may interface with MME 115 either using a direct link or via a security gateway and possibly a Home eNodeB (HeNB) gateway. When a direct link is used, a TPC 140 (e.g. TPC 140-1 in FIG. 1) that does not include eNB functionality may communicate with the MME 115 via a subset of the normal 3GPP S1 interface defined in 3GPP TS 36.413 entitled “S1 Application Protocol (S1AP),” for use between an MME and eNB. When a direct link is used, an eNB/TPC 140 (e.g. TPC 140-1 in FIG. 1) that includes eNB functionality may communicate with the MME 115 via S1 interface 105, which may be the normal 3GPP S1 interface defined in 3GPP TS 36.413 for use between an MME and eNB. When a link via a security gateway 185 and optionally via an HeNB gateway 175 is used, a TPC 140 (e.g. TPC 140-2 in FIG. 1) that does not include HeNB functionality may access MME 115 similarly to or the same as an HeNB or small cell (e.g. using an Internet connection to access the security gateway 185) but using a subset of the 3GPP S1 interface. An HeNBITPC 140 that includes HeNB functionality may access MME 115 the same as an HeNB or small cell (e.g. using the full 3GPP S1 interface).

In OTDOA based positioning, the UE 120 may measure time differences, referred to as Reference Signal Time Differences (RSTDs), between signals (e.g. PRS signals) transmitted by different pairs of eNBs and TPs. For example, the UE 120 may measure an RSTD between a PRS signal transmitted by eNB 104 and a PRS signal transmitted by TP 110-1, between a PRS signal transmitted by TP 110-1 and a PRS signal transmitted by TP 110-2, and % or between a PRS signal transmitted by eNB 104 and a PRS signal transmitted by some other eNB (not shown in FIG. 1). Typically, either one cell supported by an eNB 104 or one TP 110 will be used as a reference TP (or reference cell) and will be common to all the RSTD measurements made by the UE 120 (in the sense that each RSTD measurement may provide a time difference between a signal transmitted by the reference cell or reference TP and a signal transmitted by another neighbor eNB 104 or neighbor TP 110). The RSTDs may be used in conjunction with the known positions of eNBs/TPs to calculate the position of UE 120. The calculation may be performed by the UE 120 (e.g. if E-SMLC 155 provides the known positions to UE 120) or by the E-SMLC 155 (e.g. if UE 120 provides the measured RSTDs to E-SMLC 155).

To obtain acceptable positioning information, some or all of eNBs 104, (H)eNB/TPCs 140 and/or TPs 110 participating in OTDOA may be synchronized (e.g. to within 50 ns or better). Synchronization may ensure that common signal markers (e.g. the start of a new set of LTE radio frames, the start of an LTE subframe and/or the start a set of consecutive PRS subframes) are transmitted by an eNB 104, (H)eNB/TPC 140 and/or a TP 110 at exactly or almost exactly the same time or with precisely known time differences. In some embodiments, TPCs 140 and (H)eNB/TPCs 140 may have access to a GPS Clock, GPS timing, and/or to a GPS or other GNSS SV 180, to facilitate synchronization. For example, a TPC 140 or (H)eNB/TPC 140 may contain a GPS receiver or GNSS receiver with access to an outdoor (or indoor) antenna and may receive, measure and decode signals from one or more SVs 180 and thereby, as is well known in the art, obtain an accurate absolute time reference (such as GPS time, Coordinated Universal Time (UTC) or a time for another GNSS which may be accurate to 50 nanoseconds (ns) or better in some embodiments). In some embodiments, time synchronization information (e.g. GPS time, GNSS time, or UTC time) may be provided to TPs 110 by a TPC 140 by sending signaling information to TPs 110 that includes a time reference such as using, for example, the Internet Network Time Protocol (NTP), IEEE 1588 Precision Time Protocol (PTP) and/or an ITU-T Synchronous Ethernet.

In some embodiments, a TPC 140 may communicate with MME 115 over S1 interface 105. MME 115 may support location sessions in association with a location server such as E-SMLC 155 to provide location services for UE 120 using a CP location solution as previously described. In some embodiments, MME 115 and E-SMLC 155 may communicate over a 3GPP SLs interface 130 (e.g. as defined in 3GPP TS 29.171 entitled “LCS Application Protocol (LCS-AP) between the Mobile Management Entity (MME) and Evolved Serving Mobile Location Centre (E-SMLC); SLs interface”). UE 120 may exchange location related messages (e.g. LPP and/or LPP/LPPe messages) with the E-SMLC 155 to obtain or support location services. The location related messages may be transferred between UE 120 and E-SMLC 155 via eNB 104 and MME 115 when UE 120 is served by eNB 104 or via an (H)eNB/TPC 140 and MME 115 when UE 120 is served by eNB or HeNB functionality supported by the (H)eNB/TPC 140.

In some embodiments, E-SMLC 155 may determine a (network based or UE assisted) location of UE 120. E-SMLC 155 may use measurements of radio signals such as Positioning Reference Signals (PRS), which may be provided by a UE 120, to help determine the location of the UE 120. In some embodiments, MME 115 may communicate with Gateway Mobility Location Center (GMLC) 145 over a 3GPP SLg interface 135 (e.g. as defined in 3GPP TS 29.172 entitled “Evolved Packet Core (EPC) LCS Protocol (ELP) between the Gateway Mobile Location Centre (GMLC) and the Mobile Management Entity (MME); SLg interface”).

In some embodiments, GMLC 145 may provide an interface to one or more External Clients 165 as previously described. GMLC 145 may include functionality to support various location services (e.g. such as obtaining the location of UE 120 from MME 115 and sending the location to External Client 165). GMLC 145 may forward positioning requests related to UE 120 and received from External Client 165 to an MME 115, serving UE 120, over SLg interface 135. GMLC 145 may also forward location estimates for UE 120, received from MME 115, to External Client 165.

In some embodiments, TPC 140-2 in FIG. 1 (or some other TPC 140) may be coupled to an Operations & Maintenance (O&M) server 195, which may provide and manage configuration of TPC 140-2 and/or TPs 110 controlled by TPC 140-2. In some embodiments, TPC 140-2 and O&M server 195 may be coupled over the Internet. In some embodiments, TPC 140-2 may also, or may instead, be coupled to MME 115 through a Security Gateway 185 as previously described. Security Gateway 185 and TPC 140-2 may further be coupled over the Internet. Further, Security Gateway 185 may be coupled to (or combined with) an HeNB Gateway 175 and enable TPC 140-2 to access MME 115 (via Security Gateway 185 and HeNB gateway 175) in the same manner as an HeNB or small cell, which may avoid the need for a direct link between TPC 140 and MME 115 and thereby reduce the operational cost of deploying TPC 140-2 and TPs 110-6 and 110-7. HeNB Gateway 175 may also be coupled to MME 115 and communicate with MME 115 using an S1 interface.

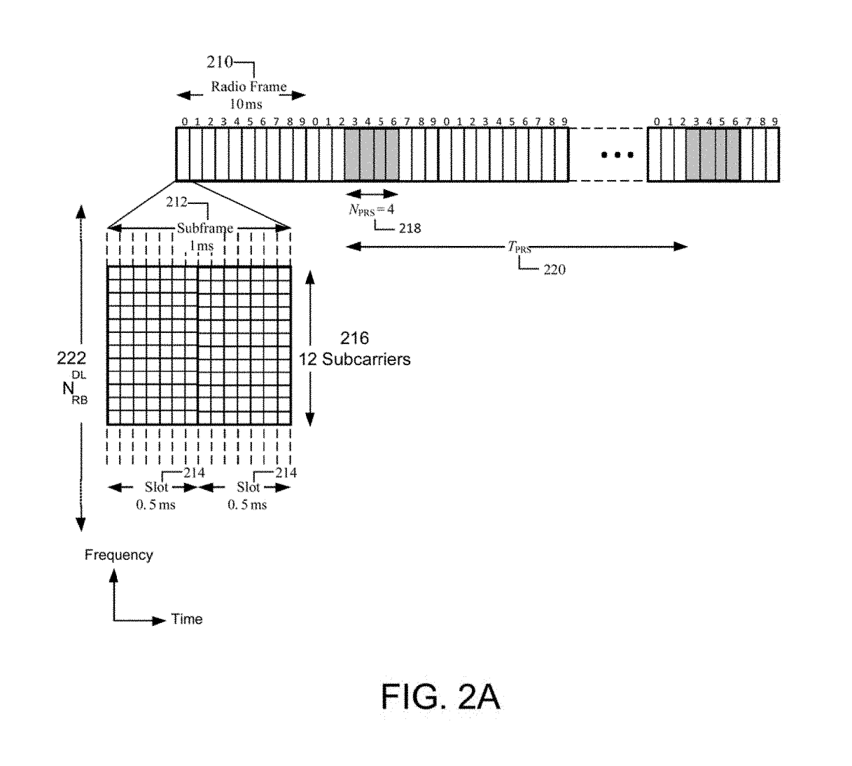

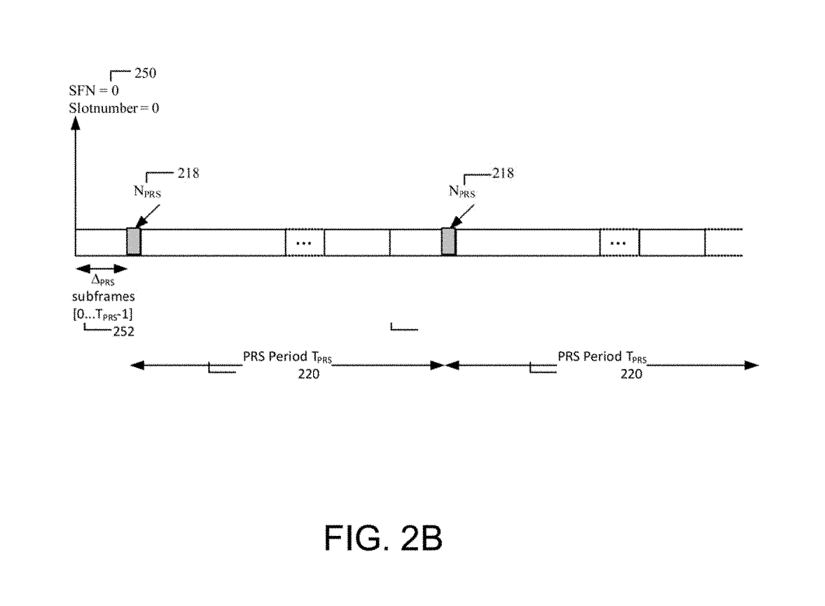

FIG. 2A shows the structure of an exemplary LTE subframe sequence with PRS positioning occasions. In FIG. 2A, time is represented horizontally (e.g. on an X axis) with time increasing from left to right, while frequency is represented vertically (e.g. on a Y axis) with frequency increasing (or decreasing) from bottom to top. As shown in FIG. 2A, downlink and uplink LTE Radio Frames 210 are of 10 ms duration each. For downlink Frequency Division Duplex (FDD) mode, Radio Frames 210 are organized into ten subframes 212 of 1 ms duration each. Each subframe 212 comprises two slots 214, each of 0.5 ms duration.

In the frequency domain, the available bandwidth may be divided into uniformly spaced orthogonal subcarriers 216. For example, for a normal length cyclic prefix using 15 KHz spacing, subcarriers 216 may be grouped into a group of 12 subcarriers. Each grouping, which comprises 12 subcarriers 216, in FIG. 2A, is termed a resource block and, in the example above, the number of subcarriers in the resource block may be written as N_{SC}^{RB}=12. For a given channel bandwidth, the number of available resource blocks on each channel 222, which is also called the transmission bandwidth configuration 222, is indicated as N_{RB}^{DL} 222. For example, for a 3 MHz channel bandwidth in the above example, the number of available resource blocks on each channel 222 is given by N_{RB}^{DL}=15.

In the LTE architecture illustrated in FIG. 1, a TP 110 may transmit a PRS (i.e. a DL PRS) such as the PRS exemplified in FIG. 2A and (as described later) FIG. 2B, which may be measured and used for UE (e.g. UE 120) position determination. Since transmission of a PRS by a TP 110 is directed to all UEs within radio range, a TP 110 can also be considered to broadcast a PRS. A TP 110 that does not support all the normal transceiver functions of an eNB but that transmits (or broadcasts) a PRS signal may be called a terrestrial beacon system (TBS) beacon, a TBS TP, a PRS TP, a positioning beacon, a positioning only beacon, a positioning only PRS beacon, a PRS beacon, an eNB beacon, a standalone eNB beacon, or a RAN beacon. As outlined above, a PRS TP may transmit downlink radio signals (e.g. PRS signals) to UEs but may refrain from broadcasting information to the UE indicating support for uplink signals from the UE.

In general, TP 110, as used herein, refers to all entities in a Radio Access Network (RAN) that transmit PRS to assist in positioning of one or more target UEs 120 and that may or may not support other functions such as providing wireless access (e.g. for voice and data connectivity) to one or more UEs 120. Further, an eNB beacon, standalone eNB beacon and RAN beacon may be particular examples of a positioning beacon. In some embodiments, TPs 110 may provide additional LTE/PRS coverage for indoor locations—e.g. may support functions of an eNB or of a remote radio head for an eNB. In some embodiments, a TP 110 may act as a standalone beacon that can transmit a PRS signal to support positioning of UEs and may also transmit information needed to support UE acquisition and measurement of the PRS such as an LTE master information block (MIB) and one or more LTE system information blocks (SIBs) but may not transmit or receive data or control information to support normal LTE access by UEs (e.g., may not support wireless access by UEs for the purpose of sending and receiving voice and data). As outlined above, a TP 110 may be coupled to a TPC 140 over a LAN or WLAN.

A PRS, which has been defined in 3GPP Long Term Evolution (LTE) Release-9 and later releases, may be transmitted by TPs 110 after appropriate configuration by a TPC 140 and/or by O&M server 195. A PRS may be transmitted in special positioning subframes that are grouped into positioning occasions. For example, in LTE, a PRS positioning occasion can comprise a number N_{PRS} of consecutive positioning subframes where the number N_{PRS} may be between 1 and 160 (e.g. may include the values 1, 2, 4 and 6 as well as other values). The PRS positioning occasions for a TP 110 may occur periodically at intervals, denoted by a number T_{PRS}, of millisecond (or subframe) intervals where T_{PRS} may equal 5, 10, 20, 40, 80, 160, 320, 640, or 1280. As an example, FIG. 2A illustrates a periodicity of positioning occasions where N_{PRS} equals 4 and T_{PRS} is greater than or equal to 20. In some embodiments, T_{PRS} may be measured in terms of the number of subframes between the start of consecutive positioning occasions.

Within each positioning occasion, a PRS may be transmitted with a constant power. A PRS can also be transmitted with zero power (i.e., muted). Muting, which turns off a regularly scheduled PRS transmission, may be useful when PRS signals between different cells overlap by occurring at the sane or almost the same time. In this case, the PRS signals from some cells may be muted while PRS signals from other cells are transmitted (e.g. at a constant power). Muting may aid signal acquisition and RSTD measurement by UEs 120 for PRS signals that are not muted by avoiding interference from PRS signals that have been muted. Muting may be viewed as the non-transmission of a PRS for a given positioning occasion for a particular cell or TP. Muting patterns may be signaled to UE 120 using bit strings. For example, in a bit string signaling a muting pattern, if a bit at position j is set to “0”, then UE 120 may infer that the PRS is muted for a j^{th} positioning occasion.

To further improve hearability of PRS, positioning subframes may be low-interference subframes that are transmitted without user data channels. As a result, in ideally synchronized networks, PRSs may receive interference from other cell PRSs with the same PRS pattern index (i.e., with the same frequency shift), but not from data transmissions. The frequency shift, in LTE, for example, is defined as a function of a PRS ID for a cell or TP (denoted as_{ID}^{PRS}) or as a function of a Physical Cell Identifier (PCI) (denoted as N_{ID}^{cell}) if no PRS ID is assigned, which results in an effective frequency re-use factor of 6.

To improve hearability of a PRS further (e.g. when PRS bandwidth is limited such as with only 6 resource blocks corresponding to 1.4 MHz bandwidth), the frequency band for consecutive PRS positioning occasions (or consecutive PRS subframes) may be changed in a known and predictable manner via frequency hopping. In addition, a TP 110, or a cell supported by an eNB 104 or a TPC 140 with eNB or HeNB functionality, may support more than one PRS configuration, where each PRS configuration comprises a distinct sequence of PRS positioning occasions with a particular number of subframes (N_{PRS}) per positioning occasion and a particular periodicity (T_{PRS}). Further enhancements of a PRS may also be supported by a TPC 140, TP 110, and/or eNB 104.

OTDOA assistance data is usually provided to a UE 120 by a location server (e.g. E-SMLC 155) for a “reference cell” and one or more “neighbor cells” or “neighboring cells” relative to the “reference cell.” For example, the assistance data may provide the center channel frequency of each cell, various PRS configuration parameters (e.g. N_{PRS}, T_{PRS}, muting sequence, frequency hopping sequence, PRS ID, PRS bandwidth), a cell global ID and/or other cell related parameters applicable to OTDOA. In the case of a TP 110 that acts as a positioning only beacon, a neighbor cell or reference cell may be equated to the TP 110 with the same or similar assistance data being provided.

PRS positioning by UE 120 may be facilitated by including the serving cell for the UE 120 in the OTDOA assistance data (e.g. with the reference cell indicated as being the serving cell). OTDOA assistance data may also include “expected RSTD” parameters, which provide the UE 120 with information about the RSTD values the UE 120 is expected to measure at its current location between the reference cell and each neighbor cell together with an uncertainty of the expected RSTD parameter. The expected RSTD together with the uncertainty define a search window for the UE 120 within which the UE 120 is expected to measure the RSTD value. OTDOA assistance information may also include PRS configuration information parameters, which allow a UE 120 to determine when a PRS positioning occasion occurs on signals received from various neighbor cells relative to PRS positioning occasions for the reference cell, and to determine the PRS sequence transmitted from various cells in order to measure a signal Time of Arrival (TOA) or RSTD.

Using the RSTD measurements, the known absolute or relative transmission timing of each cell, and the known position(s) of eNB 104 and TP 110 physical transmitting antennas for the reference and neighboring cells, the UE 120's position may be calculated. The RSTD for a cell “k” relative to a reference cell “Ref,” may be given as (TOAₖ−TOA_{Ref}). TOA measurements for different cells may then be converted to RSTD measurements (e.g. as defined in 3GPP TS 36.214 entitled “Physical layer; Measurements”) and sent to the location server (e.g. E-SMLC 155) by the UE 120. Using (i) the RSTD measurements, (ii) the known absolute or relative transmission timing of each cell, and (iii) the known position(s) of eNB 104 and TP 110 physical transmitting antennas for the reference and neighboring cells, the UE 120's position may be determined.

FIG. 2B illustrates further aspects of PRS transmission for a cell supported by an eNB 104 or for a TP 110. FIG. 2B shows how PRS positioning occasions are determined by a System Frame Number (SFN), a cell specific subframe offset (Δ_{PRS}) and the PRS Periodicity (T_{PRS}) 220. Typically, the cell specific PRS subframe configuration is defined by a “PRS Configuration Index” I_{PRS} included in the OTDOA assistance data. The PRS Periodicity (r_{PRS}) 220 and the cell specific subframe offset (Δ_{PRS}) (e.g. as shown in FIG. 2B) are defined based on the PRS Configuration Index I_{PRS}, in 3GPP TS 36.211 entitled “Physical channels and modulation,” as exemplified in Table 1 below.

TABLE 1

| | PRS periodicity | PRS subframe offset |
|---|---|---|
| PRS configuration Index | T_{PRS} | Δ_{PRS} |
| I_{PRS} | (subframes) | (subframes) |
| 0-159 | 160 | I_{PRS} |
| 160-479 | 320 | I_{PRS} − 160 |
| 480-1119 | 640 | I_{PRS} − 480 |
| 1120-2399 | 1280 | I_{PRS} − 1120 |
| 2400-2404 | 5 | I_{PRS} − 2400 |
| 2405-2414 | 10 | I_{PRS} − 2405 |
| 2415-2434 | 20 | I_{PRS} − 2415 |
| 2435-2474 | 40 | I_{PRS} − 2435 |
| 2475-2554 | 80 | I_{PRS} − 2475 |

| | |
|---|---|
| 2555-4095 | Reserved |

A PRS configuration is defined with reference to the System Frame Number (SFN) of a cell that transmits PRS. PRS instances, for the first subframe of the N_{PRS} downlink subframes comprising a first PRS positioning occasion, may satisfy:

(10×n_{f}+└nₛ/2┘−Δ_{PRS})mod T_{PRS}=0, (1)

where,

n_{f} is the SFN with 0≦n_{f}≦1023,

nₛ is the slot number within the radio frame defined by n_{f} with 0≦nₛ≦19,

T_{PRS} is the PRS periodicity, and

Δ_{PRS} is the cell-specific subframe offset.

As shown in FIG. 2B, the cell specific subframe offset Δ_{PRS} 252 may be defined in terms of the number of subframes transmitted starting from System Frame Number 0, Slot Number 0 250 to the start of the first (subsequent) PRS positioning occasion. In FIG. 2B, the number of consecutive positioning subframes 218 (Npp) equals 4.

In some embodiments, when UE 120 receives a PRS configuration index I_{PRS} in the OTDOA assistance data for a particular cell or TP 110, UE 120 may determine the PRS periodicity T_{PRS} and PRS subframe offset Δ_{PRS} using Table 1. The UE 120 may then determine the radio frame, subframe and slot when a PRS is scheduled in the cell (e.g. using equation (1)). The OTDOA assistance data may be determined by E-SMLC 155 and includes assistance data for a reference cell, and a number of neighbor cells, wherein any neighbor cell and/or the reference cell may correspond to (e.g. may be supported by) a TP 110.

Typically, PRS occasions from all cells in a network that use the same frequency are aligned in time and may have a fixed known time offset relative to other cells in the network that use a different frequency. In SFN-synchronous networks, all eNBs 104 and TPs 110 may be aligned on both frame boundary and system frame number. Therefore, in SFN-synchronous networks all cells supported by eNBs 104 and all TPs 110 may use the same PRS configuration index for any particular frequency of PRS transmission. On the other hand, in SFN-asynchronous networks all eNBs 104 and TPs 110 may be aligned on a frame boundary, but not system frame number. Thus, in SFN-asynchronous networks the PRS configuration index for each cell may be configured separately by the network so that PRS occasions align in time. Synchronization of an external TP 110 in an SFN-synchronous network (e.g. to align both frame boundaries and SFNs with other cells and TPs 110) or SFN-asynchronous network (e.g. to align frame boundaries with other cells and TPs 110) may be assisted by an accurate common time reference provided to the TP 110 by a controlling TPC 140 for the TP 110 as described previously herein.

UE 120 may determine the timing of the PRS occasions of the reference and neighbor cells for OTDOA positioning, if UE 120 can obtain the cell timing (e.g., SFN or Frame Number) of at least one of the cells (e.g. the reference cell). The timing of the other cells and TPs 110 may then be derived by UE 120, for example based on the assumption that PRS occasions from different cells and TPs 110 overlap.

In a typical macro-cell scenario, the PRS configuration parameters such as the number of consecutive positioning subframes, periodicity, muting pattern, etc. may be configured by the network and may be signaled to UE 120 by E-SMLC 155 as OTDOA assistance data. However, in instances where PRS is transmitted by TPs 110 and configured by TPCs 140, information pertaining to PRS configuration information for TPs 110 may not be available to E-SMLC 155. For example, TPs 110 may be configured locally by TPCs 140 with PRS parameters and TP 110 locations, and PRS configuration information of TPs 110 may not be available to E-SMLC 155. In such a case, E-SMLC 155 may send a message (e.g. an LPPa message) to a TPC 140 to request PRS configuration information and other information (e.g. antenna locations) for the TPs 110 controlled by the TPC 140 and the TPC 140 may return a message (e.g. an LPPa message) containing the requested information. A TPC 140 may in turn receive the PRS configuration information and other information from O&M server 195. In certain other instances, an E-SMLC 155 may be configured (e.g. by O&M server 195) with PRS configuration information and other information for the TPs 110 controlled by a TPC 140 and may send the PRS configuration information and other information for the TPs 110 to the TPC 140 (e.g. in an LPPa message) to enable the TPC 140 to configure PRS transmission in the controlled TPs 110.

Referring to FIG. 1, in some embodiments, when UE 120 requests OTDOA assistance data, or during a positioning session involving TPCs 140 and/or TPs 110, E-SMLC 155 may communicate with a TPC 140 via MME 115 to send to the TPC 140, or receive from the TPC 140, PRS configuration information and possibly other information (e.g. antenna locations and/or timing information) for TPs 110 controlled by the TPC 140. In some embodiments, the communication between E-SMLC 155 and TPCs 140 may use the LPPa protocol, which may be transported transparently through MME 115. In some embodiments, PRS configuration information pertaining to TPs 110 and the locations of TPs 110 may be provided to E-SMLC 155 in LPPa messages by a TPC 140 that controls the TPs 110. For example, E-SMLC 155 may request PRS configuration parameters for TPs 110-1 to 110-5 from TPC 140-1 in an LPPa OTDOA Information Request message. In some embodiments, TPC 140-1 may respond to the LPPa OTDOA Information Request message from E-SMLC 155 with an LPPa OTDOA Information Response message. In some embodiments, the LPPa OTDOA Information Response message may include PRS configuration information and locations for TPs 110 (e.g. one or more ofTPs 110-1-110-5).

In some embodiments, E-SMLC 155 may also request and obtain PRS configuration information and other information for TPs 110 (e.g. using LPPa) from TPCs 140 that attach to MME 115 the same as or similar to a small cell or HeNB. For example in the case of TPC 140-2, MME 115 may send messages (e.g. LPPa messages) to, and receive messages (e.g. LPPa messages) from, TPC 140-2 through: (a) MME 115 and Security Gateway 185, or (b) MME 115, HeNB Gateway 175, and Security Gateway 185. For example, the PRS Configuration and location information for TPs 110-6 and 110-7 provided by TPC 140-2 may be relayed to E-SMLC 155 over the Internet through (a) Security Gateway 185 and MM E 115, or (b) M M E 115, HeNB Gateway 175, and Security Gateway 185.

In some embodiments, upon (or some time after) receipt of the PRS configuration information and locations and other information for TPs 110, E-SMLC 155 may provide OTDOA assistance data to a UE 120 whose location is needed. In some embodiments, E-SMLC 155 may provide the OTDOA assistance data to UE 120 using the LPP protocol. For example, E-SMLC 155 may provide the OTDOA assistance data to UE 120 using an LPP Provide Assistance Data message. An LPP Provide Assistance Data message may include OTDOA assistance data such as PRS parameters (e.g. PRS bandwidth, PRS code, frequency, muting, PRS subframe configuration) for a reference cell, neighboring cells including TPs 110 that may correspond to the reference cell and/or some or all neighboring cells.

In some embodiments, after providing the OTDOA assistance data E-SMLC 155 may further send an LPP Request Location Information message to UE 120. In some embodiments, an LPP Request Location Information message may be used to request RSTD measurements from UE 120. For example, for a UE assisted mode of OTDOA positioning, UE location determination by E-SMLC 155 may be based, in part, on RSTD measurements obtained by, and sent to E-SMLC 155 by, UE 120. In some embodiments, an LPP Request Location Information message may include: information elements such as the type of location information desired; a desired accuracy for any location estimates or measurements; a response time and/or the location determination method (e.g. OTDOA) to be used.

In some embodiments, a UE 120 may obtain RSTD measurements requested by the E-SMLC 155 using assistance data provided by E-SMLC 155 (e.g. in an earlier LPP Provide Assistance Data message from E-SMLC 155). Further, UE 120 may, within the specified response time, send the obtained RSTD measurements in an LPP Provide Location Information message to E-SMLC 155. An LPP Provide Location Information message may include information elements such as one or more of RSTD measurements, quality metrics associated with the RSTD measurements, an identity of the reference cell (or reference TP 110) used for measuring the RSTDs, a quality metric related to TOA measurements for the reference cell (or reference TP 110), and a neighbor cell measurement list including identities of the measured neighbor cells, and/or measured TPs 110, for which RSTD measurements are provided.

Based on the measurements received from UE 120 in an LPP Provide Location Information message, E-SMLC 155 may determine a location of UE 120 and provide the location information to MME 115, which may relay the information to External Client 165 through GMLC 145.

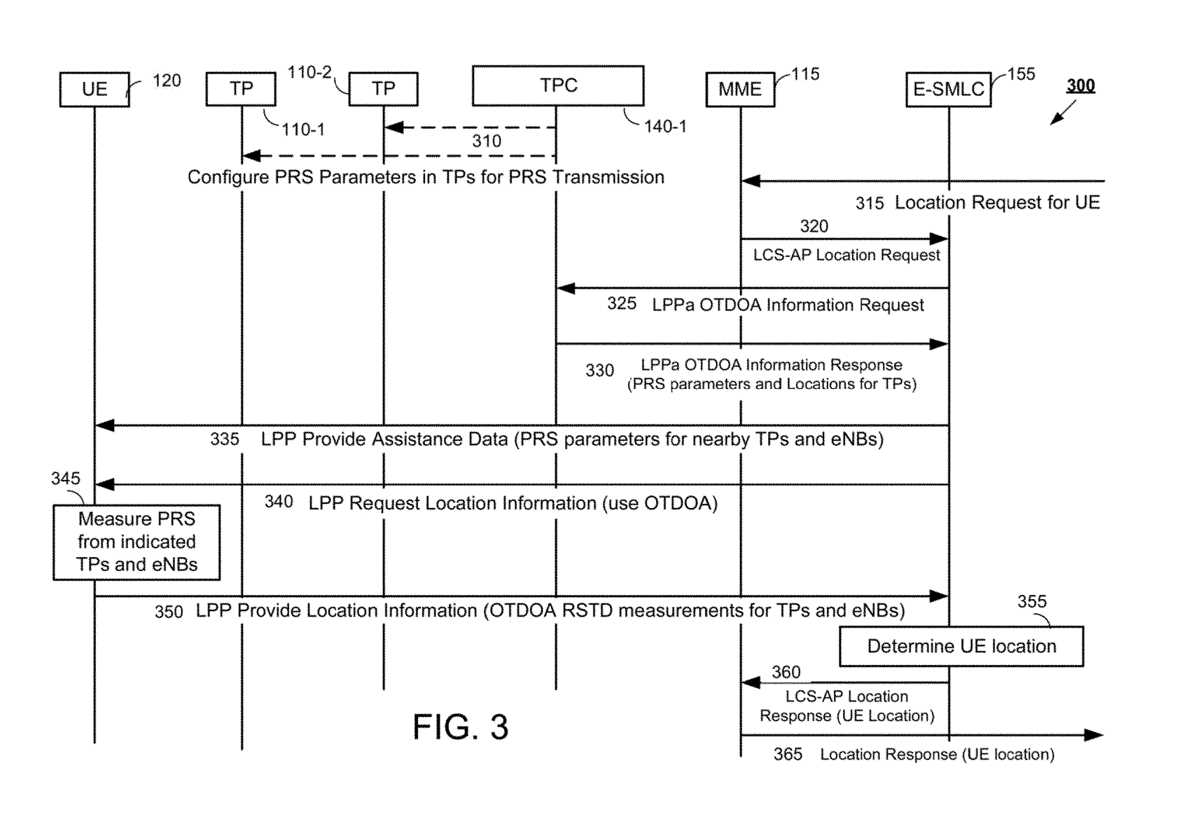

FIG. 3 shows a signaling flow 300 illustrating entities and message flows for positioning according to some disclosed embodiments. In FIG. 3, for simplicity, only two TPs (110-1 and 110-2) and one TPC (140-1) are shown. However, the message flows shown are also applicable to the other TPs coupled to TPC 140-1 and to other TPCs (e.g. TPC 140-2). For example, TPC 140-2 may be substituted for (or included in addition to) TPC 140-1 and TPs 110-6 and 110-7 may be substituted for (or included in addition to) TPs 110-1 and 110-2.

In some embodiments, at stage 310, TPC 140-1 may configure TP 110-1 and/or TP 110-2 with PRS parameters for PRS transmission (e.g. may provide PRS bandwidth, carrier frequency, coding, subframe configuration, muting pattern). The PRS parameters may have been configured at some previous time in TPC 140-1 by an O&M server 195 (not shown in FIG. 3) or by E-SMLC 155. TPC 140-1 may additionally, or instead, provide timing information to TP 110-1 and/or TP 110-2 at stage 310. For example, TPC 140-1 may send signaling information to TP 110-1 and/or TP 110-2 that includes an accurate common time reference (e.g. for GPS time, a GNSS time or UTC time), which may have been obtained by TPC 140-1 using a GPS or GNSS receiver which may, in some embodiments, be coupled to an outdoor antenna. Alternatively, or in addition, at stage 310, TPC 140-1 may request and obtain from TP 110-1 and/or TP 110-2 PRS parameters for PRS transmission by TP 110-1 and/or TP 110-2, respectively, and/or other information for TP 110-1 and/or TP 110-2 such as the location coordinates of an antenna for each of TP 110-1 and/or TP 110-2, respectively.

In some embodiments, at stage 315, MME 115 may receive a request from External Client 165 (not shown in FIG. 3) for a location of UE 120. In some embodiments, the location request at stage 315 may be forwarded to MME 115 by GMLC 145 (not shown in FIG. 3).

In some embodiments, at stage 320, MME 115 may forward the location request received at stage 315 to E-SMLC 155 (e.g. using an LCS Application Protocol (LCS-AP) Location Request message).

Upon receipt of the location request from MME 115 at stage 320, E-SMLC 155 may send an LPPa OTDOA Information Request to TPC 140-1 at stage 325 requesting PRS configuration parameters and/or other information (e.g. location coordinates) for TPs 110 (and cells) controlled by TPC 140-1 (e.g. one or more of TPs 110-1-110-5).

At stage 330, TPC 140-1 may respond to the LPPa OTDOA Information Request received from E-SMLC 155 at stage 325 with an LPPa OTDOA Information Response message. The LPPa OTDOA Information Response message may include PRS configuration parameters, TP identities, location information and/or other information for TPs 110 controlled by TPC 140-1 (e.g. one or more of TPs 110-1-110-5) such as providing for each controlled TP 110, the location coordinates of an antenna for the TP 110, PRS parameters defining PRS transmission from the TP 110, a DL carrier frequency, and an identity (ID) for the TP 110 such as a TP ID, a physical cell ID (PCI), a cell portion ID and/or a PRS ID or virtual PCI ID.

A TP ID may be a non-unique identity (e.g. an integer between 0 and 4095) assigned to an internal or external TP 110 by an O&M server 195, TPC 140-1 or by E-SMLC 155. A PRS ID may be a value (e.g. an integer between 0 and 4095) used by a TP 110 to determine a coding sequence and/or a frequency or set of frequencies used by the TP 110 to transmit a PRS. A physical cell ID may be a non-unique value (e.g. an integer between 0 and 503) used to identify an LTE cell (e.g. for an internal TP 110) or an external TP 110 within some local area. The local area may include external TPs 110 and/or LTE cells (e.g. associated with internal TPs 110) for which RSTD measurements can be obtained by UE 120 for some reference cell. TPC 140-1 may have previously obtained the information returned in the LPPa OTDOA Information Response message sent at stage 330 from an O&M server 195 and/or from TPs 110-1 and 110-2 at stage 310.

In some embodiments, at stage 335, E-SMLC 155 may send OTDOA assistance data to UE 120 using the LPP protocol (or LPP/LPPe combined protocol). For example, E-SMLC 155 may send the OTDOA assistance data to UE 120 in an LPP Provide Assistance Data message. The LPP Provide Assistance Data message may include OTDOA assistance data such as assistance data for a reference cell (e.g. PRS parameters and a reference cell ID), PRS parameters and IDs for neighboring TPs 110 (e.g. TP 110-1 and TP 110-2), and PRS configuration parameters for cells supported by neighboring eNBs 104 (not shown in FIG. 3). Some or all of the OTDOA assistance data may comprise PRS configuration parameters and IDs for TPs 110 received from TPC 140-1 at stage 330. The ID for each TP 110 may comprise a TP ID (e.g. an integer between 0 and 4095), a PRS ID (e.g. an integer between 0 and 4095) and/or a physical cell ID (e.g. an integer between 0 and 503).

In some embodiments, at stage 340, after providing the OTDOA assistance data at stage 335, E-SMLC 155 may further send an LPP (or LPP/LPPe) Request Location Information message to UE 120. In some embodiments, the LPP Request Location Information message may be used to request OTDOA RSTD measurements from UE 120. In some embodiments, the LPP Request Location Information message may include: information elements such as the type of location information desired; a desired accuracy for any location estimates/measurements; and/or a response time and/or the location determination method to be used. For example, the LPP Request Location Information message may specify that OTDOA is to be used by UE 120.

In some embodiments, at stage 345, UE 120 may measure PRS signals transmitted by TPs 110-1 and 110-2, other TPs 110, and/or other neighbor cells for other eN Bs 104 and obtain the RSTD measurements requested at stage 340 using the OTDOA assistance data received from E-SMLC 155 at stage 335. Further, at stage 350, UE 120 may, within the specified response time, send the UE determined RSTD measurements in an LPP (or LPP/LPPe) Provide Location Information message to E-SMLC 155. The LPP Provide Location Information message may include information elements such as one or more of: (i) RSTD measurements for TPs 110 (e.g. TPs 110-1 and 110-2) and other neighbor cells obtained at stage 345; (ii) the identities of the TPs 110 for which RSTD measurements are provided; (iii) the identities of other neighbor cells measured by UE 110; (iv) quality metrics associated with the RSTD measurements provided; (v) an identity of the reference cell (or reference TP 110) used for the RSTD measurements; (vi) a quality metric related to the TOA measurements from the reference cell; and/or (vii) a neighbor cell measurement list including information (e.g. RSTD measurements and TP 110 and/or cell identities as already mentioned) for measured neighbor cells.

Based on the measurements received from UE 120 at stage 350 in the LPP Provide Location Information message and on other information (e.g. previously configured locations of eNB 104 antennas and/or information for TP 110-1 and TP 110-2, such as PRS configuration parameters and locations of antennas, received at stage 330), E-SMLC 155 may determine a location of UE 120 at stage 355. The location determination at stage 355 may be based on the OTDOA position method. For example, E-SMLC may determine a geodetic location of UE 120 that may comprise coordinates (e.g. latitude, longitude, and possibly altitude) and optionally an expected error or uncertainty for the location.

In some embodiments, at stage 360, E-SMLC 155 may return the location information to MME 115, which may relay the location information to External Client 165 (e.g. through GMLC 145) at stage 365.

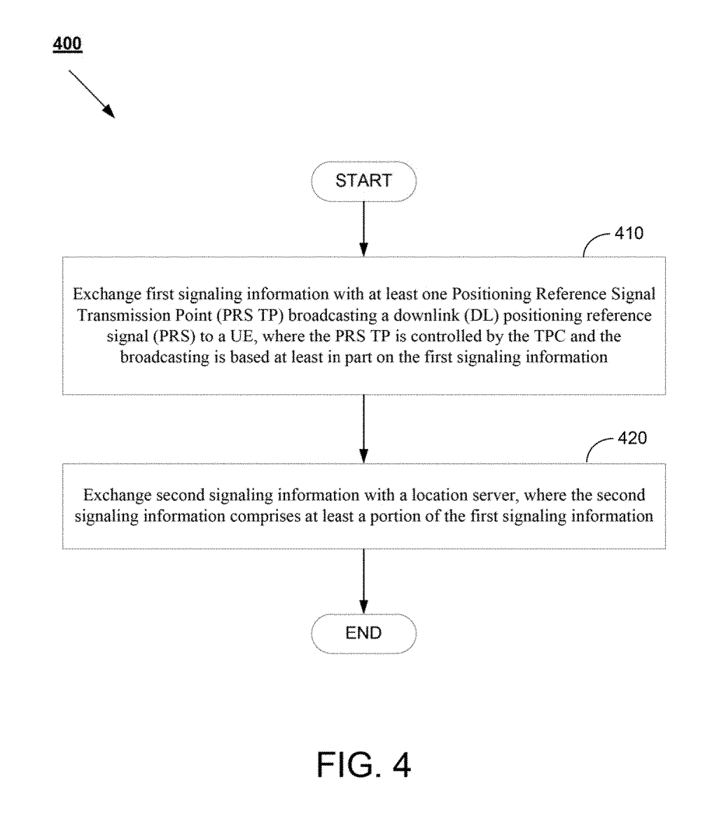

FIG. 4 shows a flowchart of an exemplary method 400 of locating a user equipment (e.g. UE 120 in system 100) by a Transmission Point Controller (e.g. TPC 140 in system 100). In some embodiments, method 400 may be performed by a TPC 140 (e.g. TPC 140-1 or TPC 140-2 in system 100), an eNB/TPC 140 or an HeNB/TPC 140.

At block 410, the TPC (e.g. TPC 140) exchanges first signaling information with at least one Positioning Reference Signal Transmission Point (PRS TP) (e.g. TP 110), where the at least one PRS TP broadcasts a downlink (DL) positioning reference signal (PRS) to the UE (e.g. UE 120), where the at least one PRS TP is controlled by the TPC and where the broadcasting is based at least in part on the first signaling information. The at least one PRS TP also refrains from broadcasting information to the UE indicating support for uplink signals from the UE. In some embodiments, the TPC (e.g. TPC 140) may send information to the at least one PRS TP to configure the at least one PRS TP (e.g. TP 110) to refrain from broadcasting information to the UE (e.g. UE 120) indicating support for uplink signals from the UE, wherein the information sent to the at least one PRS TP forms part of the first signaling information. In some embodiments, the at least one PRS TP (e.g. TP 110) may refrain from broadcasting information to the UE (e.g. UE 120) indicating support for uplink signals from the UE based on information received from the TPC (e.g. TPC 140), wherein the information received from the TPC forms part of the first signaling information.

In an embodiment, the at least one PRS TP may be an external PRS TP 110 (e.g. any of TPs 110-1 to 110-7). In an embodiment, block 410 may correspond to stage 310 in signaling flow 300. The DL PRS may be a PRS for the 3GPP OTDOA position method for LTE access by the UE (e.g. as described in relation to FIGS. 2A and 2B).

At block 420, the TPC (e.g. TPC 140) exchanges second signaling information with a location server, where the second signaling information comprises at least a portion of the first signaling information. In an embodiment, the location server may be an E-SMLC (e.g. E-SMLC 155 in system 100) or a SUPL SLP. In an embodiment, block 420 may correspond to stage 325 and/or stage 330 in signaling flow 300.

In an embodiment, the first signaling information comprises an accurate common time reference and the TPC (e.g. TPC 140) sends the first signaling information to the at least one PRS TP (e.g. TP 110) at block 410. The accurate common time reference may be a time reference for the Global Positioning System (GPS), Coordinated Universal Time (UTC) or a Global Navigation Satellite System (GNSS) and the TPC may determine the accurate common time reference using a GPS receiver or a GNSS receiver. The TPC (e.g. TPC 140) may send (or transfer) the accurate common time reference to the at least one PRS TP (e.g. TP 110) using the Internet Network Time Protocol (NTP), IEEE 1588 Precision Time Protocol (PTP) and/or Synchronous Ethernet. The at least one PRS TP may use the accurate common time reference to synchronize DL PRS transmission to the common time (e.g. in order to support an SFN-synchronous network or SFN-asynchronous network).

In an embodiment, the first signaling information exchanged at block 410 and the second signaling information exchanged at block 420 may each comprise one or more of: PRS configuration parameters for the at least one PRS TP (e.g. PRS bandwidth, PRS coding, PRS periodicity, number of subframes per PRS positioning occasion, PRS muting); an identity for the at least one PRS TP (e.g. a TP ID, PRS ID and/or PCI); a location for the at least one PRS TP (e.g. the location of an antenna for the at least one PRS TP); or some combination of the above information.

In an embodiment, the TPC (e.g. TPC 140) may receive third signaling information from an Operations and Maintenance (O&M) server (e.g. O&M server 195), where the first signaling information comprises at least part of the third signaling information and is sent by the TPC to the at least one PRS TP (e.g. TP 110) at block 410. For example, the third signaling information may comprise PRS configuration parameters for the at least one PRS TP, an identity for the at least one PRS TP (e.g. a TP ID, PRS ID and/or PCI), and/or a location for the at least one PRS TP.

In an embodiment, the TPC (e.g. TPC 140) is connected to the at least one PRS TP (e.g. TP 110) using a local area network (LAN) or a wireless LAN (WLAN).

In an embodiment, the DL PRS that is broadcast by the at least one PRS TP (e.g. TP 110) is for the 3rd Generation Partnership Project (3GPP) Long Term Evolution radio access type and may support OTDOA positioning. In this embodiment: (i) the second signaling information may be exchanged using the 3GPP LTE Positioning Protocol A (LPPa); (ii) the location server may be an E-SMLC (e.g. E-SMLC 155 in system 100); (iii) the TPC (e.g. TPC 140) may include functionality for a 3GPP eNB or 3GPP HeNB; and/or (iv) the TPC may be connected to an MME (e.g. MME 115 in system 100) using a 3GPP S1 interface or a subset of a 3GPP S1 interface. In the case that the second signaling information is exchanged using LPPa, the TPC (e.g. TPC 140) may receive an LPPa OTDOA Information Request message from the location server (e.g. E-SMLC 155) requesting OTDOA related information for TPs (e.g. internal and/or external TPs 110) controlled by the TPC as in stage 325 of signaling flow 300, and the TPC may return an LPPa OTDOA Information Response message to the location server as in stage 330 of signaling flow 300 that includes information for the at least one PRS TP controlled by the TPC such as PRS configuration parameters, a TP ID and/or a TP location.

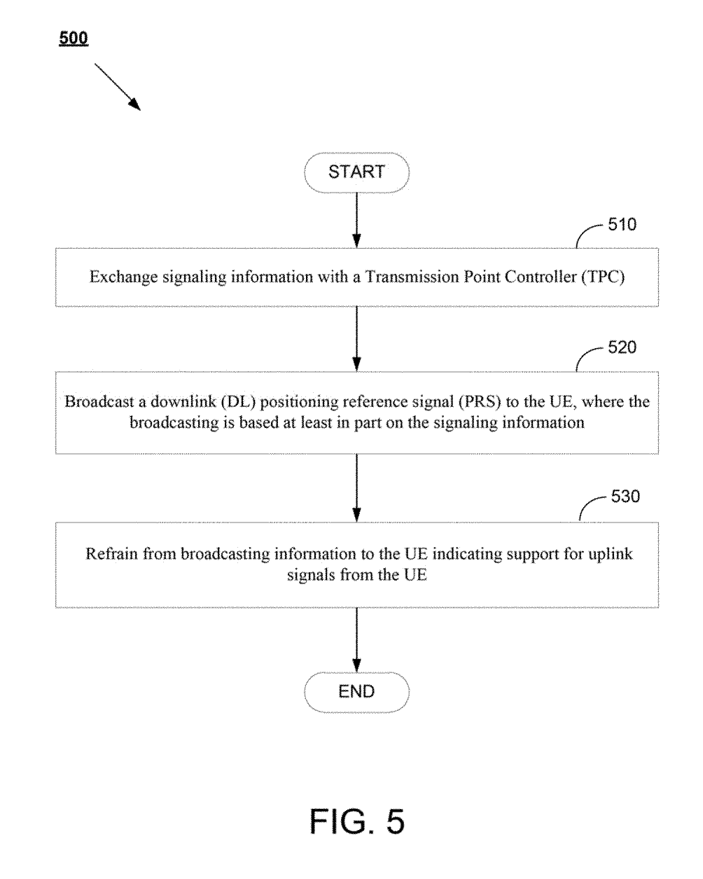

FIG. 5 shows a flowchart of an exemplary method 500 of locating a user equipment (e.g. UE 120 in system 100) by a Transmission Point (e.g. TP 110). In some embodiments, method 500 may be performed by an external TP 110 and/or by a PRS TP 110 (e.g. any of TPs 110-1 to 110-7 in system 100).

At block 510, the TP (e.g. TP 110) exchanges signaling information with a Transmission Point Controller (e.g. TPC 140-1 or TPC 140-2 in system 100). In some embodiments, block 510 may correspond to stage 310 in signaling flow 300.

At block 520, the TP (e.g. TP 110) broadcasts (or transmits) a downlink (DL) positioning reference signal (PRS) to the UE (e.g. UE 120), where the broadcasting is based at least in part on the signaling information exchanged at block 510.

In some embodiments, at block 530, the TP may refrain from broadcasting (or transmitting) information to the UE indicating support for uplink signals from the UE (e.g. UE 120). In some embodiments, at block 530, the TP (e.g. TP 110) may be configured (e.g. by TPC 140 and/or TP 110) to indicate that the TP does not support uplink signals from the UE (e.g. UE 120). In some embodiments, the TP (e.g. TP 110) may indicate a lack of support for uplink signals from the UE (e.g. UE 120) by refraining from broadcasting information to the UE indicating support for uplink signals from the UE. For example, the TP may refrain from broadcasting an LTE MIB, SIB1, and/or SIB2 message to the UE. In some embodiments, the TP (e.g. TP 110) may refrain from broadcasting information to the UE (e.g. UE 120) indicating support for uplink signals from the UE based on information received from the TPC (e.g. TPC 140), wherein the information received from the TPC forms part of the signaling information. In some embodiments, the TP (e.g. TP 110) may send information to the TPC indicating that the TP refrains from broadcasting information to the UE indicating support for uplink signals from the UE, wherein the information sent to the TPC forms part of the signaling information.

In an embodiment, the signaling information may comprise an accurate common time reference and is received by the TP (e.g. TP 110) from the TPC (e.g. TPC 140). The TP (e.g. TP 110) may receive the accurate common time reference from the TPC (e.g. TPC 140) using the Internet Network Time Protocol (NTP), IEEE 1588 Precision Time Protocol (PTP) and/or Synchronous Ethernet. The TP (e.g. TP 110) may use the accurate common time reference to synchronize the DL PRS broadcast at block 520 to the common time reference (e.g. in order to support an SFN-synchronous network or SFN-asynchronous network). The accurate common time reference may be a time reference for the Global Positioning System (GPS), Coordinated Universal Time (UTC) or a Global Navigation Satellite System (GNSS) and may have been obtained by the TPC (e.g. TPC 140) using a GPS receiver or a GNSS receiver. The TP (e.g. TP 110) may synchronize the broadcast of the DL PRS to the accurate common time reference. For example, the TP may align the transmission of the start of each new LTE radio frame with a 10 ms time boundary for the common time reference and/or may align the transmission of a PRS positioning occasion to an interval of time, according to the common time reference, during which other TPs (e.g. other TPs 110) that are synchronized to the common time reference are also broadcasting a PRS positioning occasion.

In an embodiment, the signaling information in block 510 may comprise one or more of: PRS configuration parameters for the TP (e.g. PRS bandwidth, PRS coding, PRS periodicity, number of subframes per PRS positioning occasion, PRS muting, PRS frequency hopping); an identity for the TP (e.g. a TP ID, PRS ID and/or PCI); a location for the TP (e.g. the location of an antenna for the TP); or some combination of the above information. In this embodiment, the TP (e.g. TP 110) may receive the signaling information from the TPC (e.g. TPC 140) at block 510 and the TPC may receive the signaling information from an Operations and Maintenance (O&M) server (e.g. O&M server 195 in system 100). Alternatively in this embodiment, the TP (e.g. TP 110) may be pre-configured with the signaling information and may send the signaling information to the TPC (e.g. TPC 140) at block 510.

In an embodiment, the TP is connected to the TPC using a local area network (LAN) or a wireless LAN (WLAN).

In an embodiment, the DL PRS broadcast at block 520 is for the 3GPP LTE radio access type and may enable measurement of an OTDOA RSTD by the UE between the DL PRS broadcast at block 520 by the TP and a DL PRS broadcast by some other TP 110 or eNB 104. In this embodiment, the TPC may include functionality for a 3GPP eNB or HeNB.

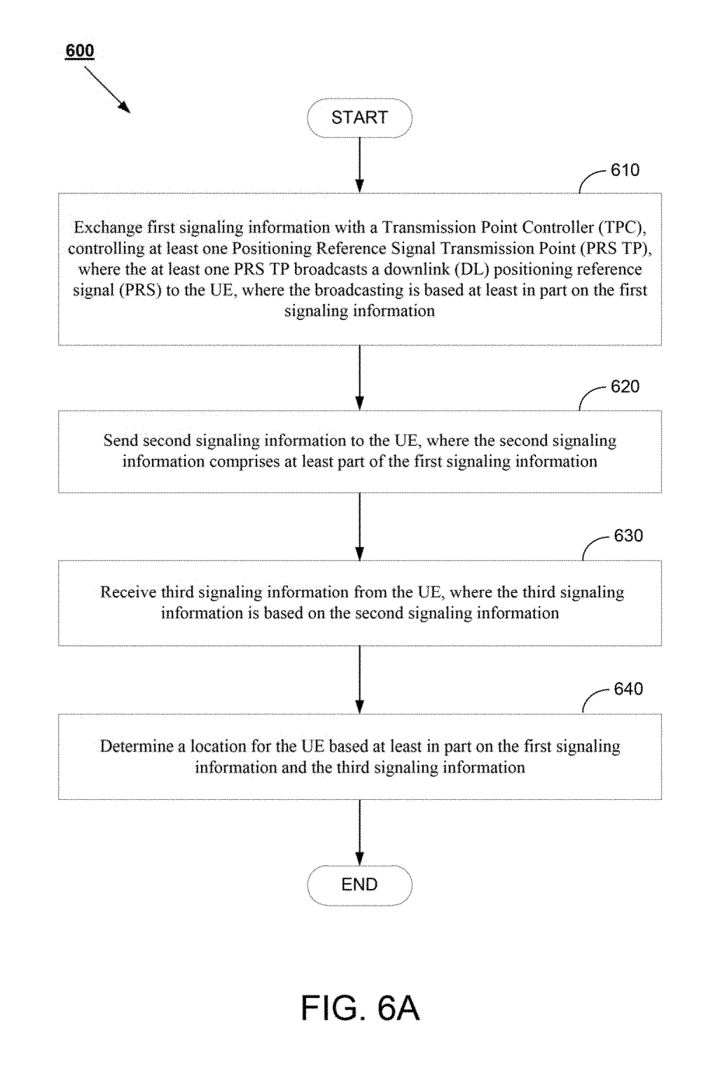

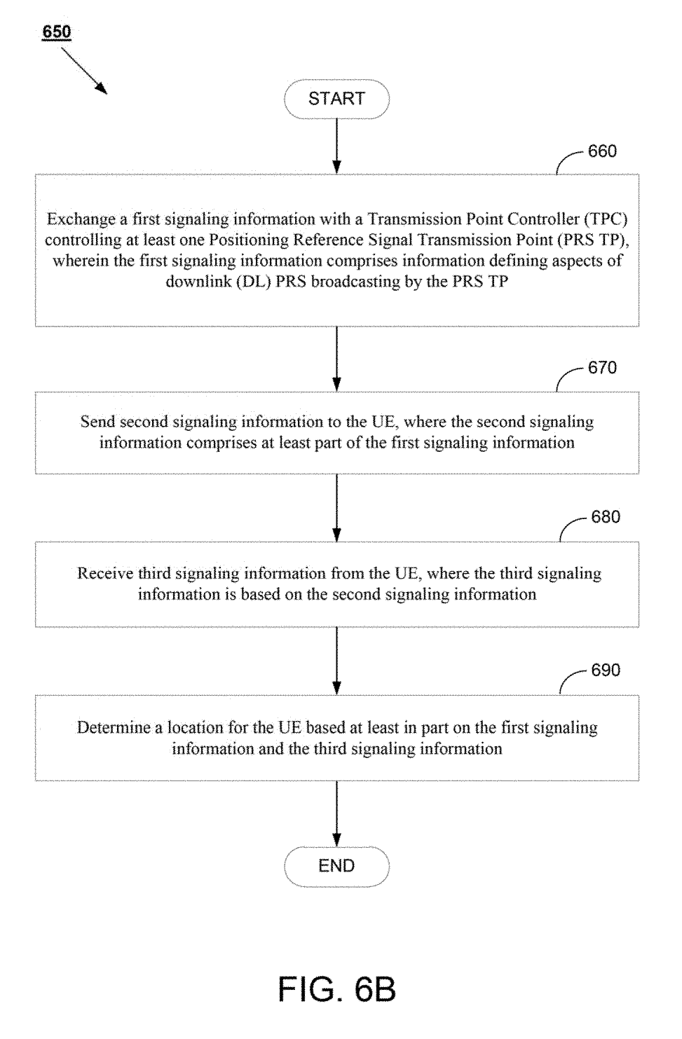

FIG. 6A shows a flowchart of an exemplary method 600 of locating a user equipment (e.g. UE 120 in system 100) by a location server (e.g. an E-SMLC or a SUPL SLP). In some embodiments, method 600 may be performed by E-SMLC 155 in system 100.

In some embodiments, at block 610, the location server exchanges first signaling information with a Transmission Point Controller (TPC) (e.g. TPC 140-1 or TPC 140-2 in system 100) controlling at least one Positioning Reference Signal Transmission Point (PRS TP), where the at least one PRS TP broadcasts a downlink (DL) positioning reference signal (PRS) to the UE, and where the broadcasting is based at least in part on the first signaling information. The at least one PRS TP may refrain from broadcasting information to the UE (e.g. a MIB, SIB1 or SIB2) indicating support by the at least one PRS TP for uplink signals from the UE. The at least one PRS TP may correspond to an external TP 110 in system 100 (e.g. any of TPs 110-1 to 110-7). In an embodiment, block 610 may correspond to stages 325 and 330 in signaling flow 300.

At block 620, the location server (e.g. an E-SMLC or a SUPL SLP) sends or initiates transmission of second signaling information to the UE (e.g. UE 120), where the second signaling information includes at least part of the first signaling information. In an embodiment, block 620 may correspond to stage 335 in signaling flow 300.

At block 630, the location server (e.g. an E-SMLC or a SUPL SLP) may receive third signaling information from the UE (e.g. UE 120), where the third signaling information is based on the second signaling information. In an embodiment, block 630 may correspond to stage 350 in signaling flow 300.

At block 640, the location server (e.g. an E-SMLC or a SUPL SIP) may determine a location for the UE (e.g. UE 120) based at least in part on the first signaling information and the third signaling information. In an embodiment, block 640 may correspond to stage 355 in signaling flow 300.

In an embodiment, the first signaling information exchanged at block 610 may comprise one or more of: PRS configuration parameters for the at least one PRS TP (e.g. PRS bandwidth, PRS coding, PRS periodicity, number of subframes per PRS positioning occasion, PRS muting, PRS frequency hopping); an identity for the at least one PRS TP (e.g. a TP ID, PRS ID and/or a PCI); a location for the at least one PRS TP (e.g. a location of an antenna for the at least one PRS TP); or some combination of the above information. In this embodiment, the first signaling information may be received by the location server from the TPC (e.g. TPC 140) at block 610—e.g. following a request sent by the location server to the TPC at block 610 requesting information for TPs (e.g. TPs 110 and/or PRS TPs 110) controlled by the TPC.

In an embodiment, the TPC, with which the first signaling information is exchanged at block 610, is connected to the at least one PRS TP using a local area network (LAN) or a wireless LAN (WLAN).

In an embodiment, the DL PRS broadcast by the at least one PRS TP is for the 3GPP LTE radio access type. In this embodiment, the first signaling information may be exchanged using the 3GPP LTE Positioning Protocol A (LPPa). For example the location server may send an LPPa OTDOA Information Request message to the TPC to request OTDOA related information for TPs (e.g. internal and/or external TPs 110 and/or PRS TPs 110) controlled by the TPC as at stage 325 of signaling flow 300, and the TPC may return an LPPa OTDOA Information Response message to the location server as at stage 330 of signaling flow 300 that includes information for the least one PRS TP controlled by the TPC such as PRS configuration parameters, a TP ID and/or a TP location. In this embodiment, the TPC may include functionality for a 3GPP eNB or a 3GPP HeNB (e.g. the TPC may be an eNB/TPC 110 or HeNB/TPC 110 in system 100). In this embodiment, the second signaling information may be sent at block 620 and the third signaling information may be received at block 630 using the 3GPP LPP protocol or using LPP/LPPe.

When the second signaling information is sent at block 620 and the third signaling information is received at block 630 using LPP or LPP/LPPe, the second signaling information may comprise an LPP Provide Assistance Data message (e.g. as at stage 335 in signaling flow 300), and the third signaling information may comprise an LPP Provide Location Information message (e.g. as at stage 350 in signaling flow 300). The location server may further determine the location for the UE at block 640 based at least in part on the 3GPP OTDOA position method.

FIG. 6B shows a flowchart of an exemplary method 650 of locating a user equipment (e.g. UE 120 in system 100) by a location server (e.g. an E-SMLC or a SUPL SLP). In some embodiments, method 650 may be performed by E-SMLC 155 in system 100.

In some embodiments, at block 660, the location server exchanges first signaling information with a Transmission Point Controller (TPC) (e.g. TPC 140-1 or TPC 140-2 in system 100) controlling at least one Positioning Reference Signal Transmission Point (PRS TP), wherein the first signaling information comprises information defining aspects of downlink (DL) PRS broadcasting by the PRS TP. The at least one PRS TP may refrain from broadcasting information to the UE (e.g. a MIB, SIB 1 or SIB2) indicating support by the at least one PRS TP for uplink signals from the UE. The at least one PRS TP may correspond to an external TP 110 in system 100 (e.g. any of TPs 110-1 to 110-7). In an embodiment, block 660 may correspond to stages 325 and 330 in signaling flow 300.

At block 670, the location server (e.g. an E-SMLC or a SUPL SLP) sends or initiates transmission of second signaling information to the UE (e.g. UE 120), where the second signaling information includes at least part of the first signaling information. In an embodiment, block 670 may correspond to stage 335 in signaling flow 300.

At block 680, the location server (e.g. an E-SMLC or a SUPL SLP) may receive third signaling information from the UE (e.g. UE 120), where the third signaling information is based on the second signaling information. In an embodiment, block 680 may correspond to stage 350 in signaling flow 300.

At block 690, the location server (e.g. an E-SMLC or a SUPL SIP) may determine a location for the UE (e.g. UE 120) based at least in part on the first signaling information and the third signaling information. In an embodiment, block 690 may correspond to stage 355 in signaling flow 300.

In an embodiment, the first signaling information exchanged at block 660 may comprise one or more of: PRS configuration parameters for the at least one PRS TP (e.g. PRS bandwidth, PRS coding, PRS periodicity, number of subframes per PRS positioning occasion, PRS muting, PRS frequency hopping); an identity for the at least one PRS TP (e.g. a TP ID, PRS ID and/or a PCI); a location for the at least one PRS TP (e.g. a location of an antenna for the at least one PRS TP); or some combination of the above information. In this embodiment, the first signaling information may be received by the location server from the TPC (e.g. TPC 140) at block 660—e.g. following a request sent by the location server to the TPC at block 660 requesting information for TPs (e.g. TPs 110 and/or PRS TPs 110) controlled by the TPC.

In an embodiment, the TPC, with which the first signaling information is exchanged at block 660, is connected to the at least one PRS TP using a local area network (LAN) or a wireless LAN (WLAN).

In an embodiment, the DL PRS broadcast by the at least one PRS TP is for the 3GPP LTE radio access type. In this embodiment, the first signaling information may be exchanged using the 3GPP LTE Positioning Protocol A (LPPa). For example the location server may send an LPPa OTDOA Information Request message to the TPC to request OTDOA related information for TPs (e.g. internal and/or external TPs 110 and/or PRS TPs 110) controlled by the TPC as at stage 325 of signaling flow 300, and the TPC may return an LPPa OTDOA Information Response message to the location server as at stage 330 of signaling flow 300 that includes information for the least one PRS TP controlled by the TPC such as PRS configuration parameters, a TP ID and/or a TP location. In this embodiment, the TPC may include functionality for a 3GPP eNB or a 3GPP HeNB (e.g the TPC may be an eNB/TPC 110 or HeNB/TPC 110 in system 100). In this embodiment, the second signaling information may be sent at block 670 and the third signaling information may be received at block 680 using the 3GPP LPP protocol or using LPP/LPPe.

When the second signaling information is sent at block 670 and the third signaling information is received at block 680 using LPP or LPP/LPPe, the second signaling information may comprise an LPP Provide Assistance Data message (e.g. as at stage 335 in signaling flow 300), and the third signaling information may comprise an LPP Provide Location Information message (e.g. as at stage 350 in signaling flow 300). The location server may further determine the location for the UE at block 690 based at least in part on the 3GPP OTDOA position method.

The embodiments and examples of the method and techniques so far described (e.g. in relation to FIGS. 1-6B above) have generally assumed that positioning is used for a UE 120 with LTE wireless access to some EPS serving network (e.g. to an eNB 104 and MME 115 in an EPS). However, the method and techniques may be applicable to other types of wireless access by a UE 120 such as using LTE Advanced (LTE-A) or the New Radio (NR) and Fifth Generation (5G) wireless access types being developed by 3GPP. Thus, for example, the method and techniques may be applicable to position methods similar to or the same as OTDOA, where time difference measurements similar to or the same as RSTDs, or other measurements, are obtained by a UE 120 based on downlink signals received and measured from TPs 110. The TPs 110 may be controlled by a TPC 140 and the downlink signals may conform to a different radio access type such as LTE-A, NR, or 5G. In addition, the method and techniques may be applicable to other downlink position methods, such as Enhanced Cell ID (ECID), in which a UE 120 obtains measurements of downlink signals transmitted by TPsl 10 controlled by a TPC 140.

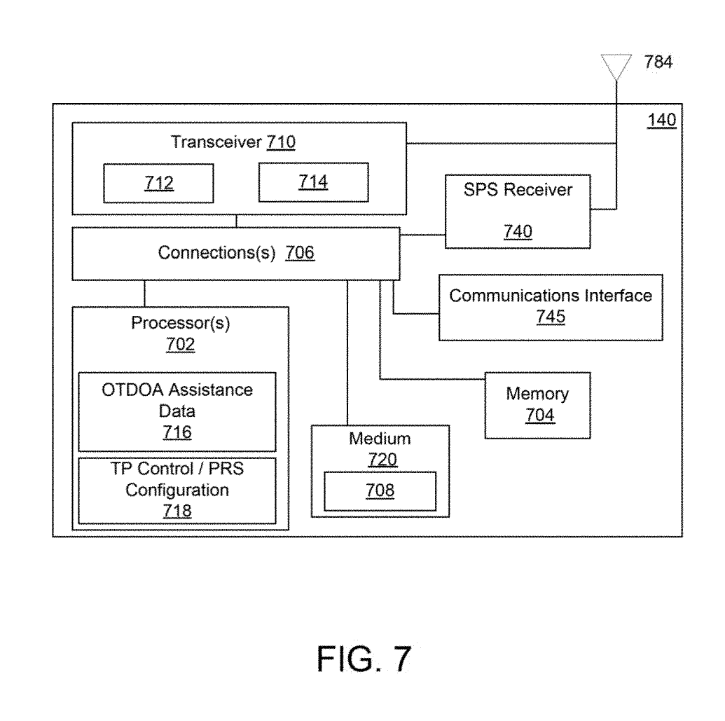

FIG. 7 shows a schematic block diagram illustrating certain exemplary features of a TPC 140 such as TPC 140-1 or TPC 140-2 in system 100. The TPC 140 may support the methods and techniques described herein with respect to FIGS. 1-6B. The TPC 140 may further be an eNB/TPC, HeNB/TPC or a TPC 140 that does not include eNB or HeNB functionality.

In some embodiments, TPC 140 may, for example, include one or more processor(s) 702, memory 704, a transceiver 710 (e.g., a wireless and/or wireline network interface), and (as applicable) an SPS receiver 740, which may be operatively coupled with one or more connections 706 (e.g. buses, lines, fibers, links, etc.) to a non-transitory computer-readable medium 720 and memory 704. The SPS receiver 740 may comprise a GPS receiver or GNSS receiver, and may be enabled to receive signals associated with one or more SPS resources such as one or more Earth orbiting Space Vehicles (SVs) 180, which may be part of a satellite positioning system (SPS) such as a GNSS. SVs 180, for example, may be in a constellation of a Global Navigation Satellite System (GNSS) such as the US Global Positioning System (GPS), the European Galileo system, the Russian GLONASS system, or the Chinese BeiDou system. In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, and/or various augmentation systems (e.g., an Satellite Based Augmentation System (SBAS)) that may be associated with or otherwise enabled for use with one or more global and/or regional navigation satellite systems.

By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS. In some embodiments, SPS receiver 740 may receive GPS or other GNSS Clock and correction information to facilitate synchronization with other TPCs 140. For example, SPS receiver 740 may enable TPC 140 to determine an accurate common time reference (e.g. for GPS, GNSS or UTC time) which may be transferred to one or more TPs 110 controlled by TPC 140. For example, clock synchronization and timing information may be provided to TPs 110 by TPC 140 for PRS transmission.

Transceiver 710 may, for example, include a transmitter 712 enabled to transmit one or more signals over one or more types of wireless and/or wireline communication networks and communication links, and a receiver 714 to receive one or more signals transmitted over the one or more types of wireless and/or wireline communication networks and communication links. For example, transceiver 710 may transmit and receive LTE signals to/from UEs 120. Further, transceiver 710 may transmit and receive signals to one or more TPs 110 via a WLAN or LAN. In addition, transceiver 710 may transmit and receive signals to and from an MME 115 (e.g. via a 3GPP S1 interface) and/or to an E-SMLC 155. Transceiver 710 may be coupled to a communications interface 745 which may format and encode messages and signals (e.g. LPPa messages) transmitted by transceiver 710 and decode and interpret messages and signals (e.g. LPPa messages) received by transceiver 710.

Processor(s) 702 may be implemented using a combination of hardware, firmware, and software. In some embodiments, processor(s) 702 may include OTDOA Assistance Data component 716, which may process LPPa or other requests for OTDOA assistance information related to PRS configuration of TPs 110 configured by TPC 140 and/or location information of TPs 110 coupled to TPC 140. In some embodiments, processor(s) 702 may include TP control/PRS configuration component 718, which may exchange signaling with TPs 110 controlled by TPC 110 in order to configure or retrieve information (e.g. PRS configuration parameters) in or from TPs 110 and/or provide an accurate common time reference to TPs 110. In some embodiments, processor(s) 702 and/or OTDOA Assistance Data component 716 may perform some or all of method 400 and portions of signaling flow 300. In some embodiments, processor(s) 702/OTDOA Assistance Data component 716 may store and provide current PRS configuration information for TPs 110 coupled to TPC 140 (e.g. using the LPPa protocol).

When TPC 140 serves as an eNB or HeNB (i.e. is an eNB/TPC 140 or HeNB/TPC 140), processor(s) 702 may provide appropriate eNB or HeNB functionality. When TPC 140 serves as a TPC, processor(s) 702 and/or TP control/PRS configuration component 718 may provide appropriate functionality to configure TPs 110 with PRS transmission information, control TPs 110, and/or monitor TP 110 performance. In some embodiments. TPC 140 may serve as both an eNB or HeNB and a TPC. In some embodiments, TPC 140 may be able to communicate with E-SMLC 155 and/or MME 115 using LPPa messages. In some embodiments, when serving as an eNB or HeNB, TPC 140 may also relay LPP messages between UE 120 and E-SMLC 155.

In some embodiments, TPC 140 and/or one or more of: processor(s) 702, OTDOA Assistance Data component 716, or TP Control/PRS Configuration component 718 may facilitate location determination for a UE 120 as outlined further below. In some embodiments, a first signaling information may be exchanged with a PRS TP 110 controlled by TPC 140 (e.g. using transceiver 710 or communications interface 745), wherein the PRS TP 110 broadcasts a downlink (DL) positioning reference signal (PRS) to UE 120, and where the broadcasting of the DL PRS signal is based on the first signaling information. As outlined previously, PRS TP 110 refrains from broadcasting information to UE 120 indicating support for uplink signals from UE 120. Exchanging the first signaling information may comprise sending the first signaling information to the PRS TP 110, wherein the first signaling information comprises a common time reference. In some embodiments, the common time reference may be determined based on input from a GPS receiver or a GNSS receiver (e.g. SPS receiver 740) coupled to the TPC 140, wherein the common time reference is a time reference for one of: the Global Positioning System (GPS), or a Coordinated Universal Time (UTC), or a Global Navigation Satellite System (GNSS). In some embodiments, the DL PRS may be for the 3GPP LTE radio access type.

Further, in some embodiments, a second signaling information may be exchanged by TPC 140 (e.g. using communications interface 745) with a location server, wherein the second signaling information comprises at least part of the first signaling information. In some embodiments, the first signaling information and the second signaling information may each comprise PRS configuration parameters for the PRS TP 110, an identity of the PRS TP 110, a location of the PRS TP 110, or some combination thereof. In embodiments where the DL PRS may be for the 3GPP LTE radio access type, the second signaling information may be exchanged using the 3GPP LTE Positioning Protocol A (LPPa).

In some embodiments, TPC 140 may receive third signaling information from an Operations and Maintenance (O&M) server communicatively coupled to the TPC; and when exchanging the first signaling information with the PRS TP 110 may send the first signaling information to the PRS TP 110, where the first signaling information comprises a portion of the third signaling information.

In some embodiments, the TPC 140 may be communicatively coupled to the PRS TP 110 using a Local Area Network (LAN) or a Wireless LAN (WLAN). In embodiments where the DL PRS may be for the 3GPP LTE radio access type, the location server may be E-SMLC 155 or an SLP. When the DL PRS is for the 3GPP LTE radio access type, TPC 140 may include functionality for a 3GPP eNB or a 3GPP HeNB. Further, in some embodiments, TPC 140 may be communicatively coupled to an MME (e.g. MME 115) using a 3GPP S1 interface or a subset of a 3GPP S1 interface.

In some embodiments, TPC 140 may include one or more antennas 784, which may be internal or external to TPC 140. Antennas 784 may be used to transmit and/or receive signals processed by transceiver 710 and/or SPS receiver 740. In some embodiments, antennas 784 may be coupled to transceiver 710 and SPS receiver 740.

The methodologies described herein may be implemented by various means depending upon the application. For example, these methodologies may be implemented in hardware, firmware, software, or any combination thereof. For a hardware implementation, the processor(s) 702, OTDOA Assistance Data component 716 and/or TP Control/PRS Configuration component 718 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with microcode, procedures, functions, and so on that perform the functions described herein. Any machine-readable medium tangibly embodying instructions may be used in implementing the methodologies described herein. For example, software code may be stored in a non-transitory computer-readable medium 720 or memory 704 that is coupled to and executed by processor(s) 702. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may also be stored as one or more instructions or program code 708 on a non-transitory computer-readable medium, such as medium 720 and/or memory 704. Examples include computer-readable media encoded with a data structure and computer-readable media encoded with a computer program 708. For example, the non-transitory computer-readable medium including program code 708 stored thereon may include program code 708 to: support provision of configuration information for TPs 110 (e.g. PRS parameters and location information) to other entities including E-SMLC 155; support LPPa; and/or support PRS configuration and control of TPs 110, etc.

Non-transitory computer-readable media 720 includes physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code 708 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Memory 704 may represent any data storage mechanism. Memory 704 may include, for example, a primary memory and/or a secondary memory. Primary memory may include, for example, a random access memory, read only memory, etc. While illustrated in this example as being separate from processor(s) 702, it should be understood that all or part of a primary memory may be provided within or otherwise co-located/coupled with processor(s) 702. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer-readable medium 720. As such, in certain example implementations, the methods and/or apparatuses presented herein may take the form in whole or part of a computer-readable medium 720 that may include computer implementable instructions 708 stored thereon, which if executed by at least one processor(s) 702 may be operatively enabled to perform all or portions of the example operations as described herein. Computer readable medium 720 may be a part of memory 704.

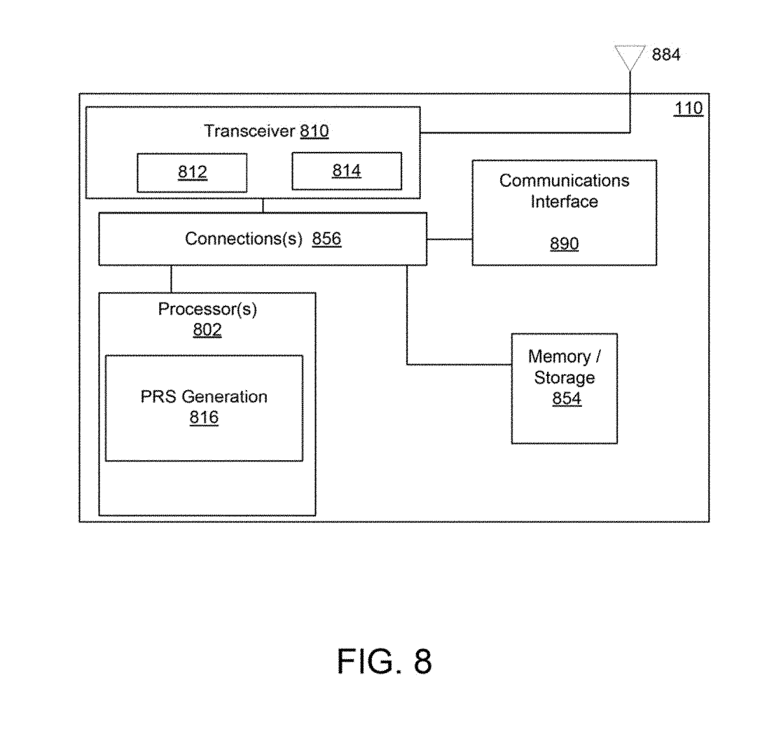

Reference is now made to FIG. 8, which is a schematic block diagram illustrating a TP 110 such as any of TPs 110-1 to 110-7 in system 100. TP 110 may be configured to support any of the methods and techniques described herein in FIGS. 1-6B. TP 110 may be an external TP 110 and/or a PRS TP 110.

In some embodiments, TP 110 may communicate with a controlling TPC 140 over a Local Area Network (LAN) or Wireless LAN (WLAN) through a network interface, which may comprise transceiver 810 and/or communications interface 890. TP 110 may act as positioning beacon and may transmit PRS (e.g. using transceiver 810) after being appropriately configured by a controlling TPC 140, HeNB/TPC 140 or eNB/TPC 140.

TP 110 may transmit a PRS, which may be measured and used for UE position determination. TP 110 may also be called a positioning beacon, eNB beacon, standalone or eNB beacon. In general, TP 110, as used herein, refers to any entity in a RAN that transmits PRS to assist in positioning of one or more target UEs 120 (based on configuration by a TPC 140) and that may or may not support other functions such as providing wireless access (e.g. for voice and data connectivity) to one or more UEs 120. Further, an eNB beacon and standalone eNB beacon may be particular examples of a positioning beacon. In some embodiments, TP 110 may provide additional LTE/PRS coverage for indoor locations. In some embodiments, TP 110 may act as a standalone beacon that can transmit a PRS signal to support positioning of UEs and may also transmit information needed to support UE acquisition and measurement of the PRS such as an LTE master information block (MIB) and one or more LTE system information blocks (SIBs) but may not transmit or receive data or control information to support normal LTE access by UEs (e.g., may not support wireless access by UEs 120 for the purpose of sending and receiving voice and data).

In some embodiments, TP 110 may include, for example, one or more processor(s) 802, memory/storage 854, communications interface 890 (e.g., a wireline and/or wireless network interface), which may be operatively coupled with one or more connections 856 (e.g., buses, lines, fibers, links, etc.). In certain example implementations, some portion of TP 110 may take the form of a chipset, and/or the like.

Communications interface 890 may include support for a variety of wired (or wireline) communication interfaces that support wired transmission and/or reception and, if desired, may additionally or alternatively support transmission and reception of one or more signals over one or more types of wireless communication networks such as LTE radio links, WLANs or microwave links. Communication over a WLAN with TPC 140 may be supported, in part, by transceiver 810, which may comprise transmitter 812 and receiver 814.

Communications interface 890 may also support communication with TPC 140 over wired networks. In some embodiments, communications interface 890 may receive clock or timing synchronization information from TPC 140, such as an accurate common time reference (e.g. for GPS, GNSS or UTC time), for accurate (e.g. synchronized) transmission of PRS signals. In one embodiment, communications interface 890 may comprise network interface cards, input-output cards, chips and/or ASICs that implement one or more of the communication functions performed by TP 110.

In some embodiments, communications interface 890 may interface with a TPC 140 to obtain a variety of network configuration related information, such as PRS configuration information and/or timing information used by TP 110. Processor(s) 802 and/or PRS generation component 816 may use some or all of the received information to generate PRS signals, which may be transmitted using transceiver 810 and antennas 884 in a manner consistent with disclosed embodiments.

Processor(s) 802 may be implemented using a combination of hardware, firmware, and software. In some embodiments, processor(s) 802 may include PRS generation component 816 to generate PRS signals for transmission. In some embodiments, processor(s) 802 may represent one or more circuits configurable to perform at least a portion of a data signal computing procedure or process related to the configuration and generation of PRS signals by TP 110.

In some embodiments, TP 110 and/or one or more of: processor(s) 802 or PRS generation component 816 may perform methods to facilitate location determination for a User Equipment (UE) 120 as outlined further below. In some embodiments, TP 110 may exchange a signaling information with a TPC 140. Further, TP 110 may broadcast a downlink (DL) positioning reference signal (PRS) to the UE 120, wherein the broadcast of the DL PRS may be based on the signaling information; and may refrain from broadcasting information to UE 120 indicating support for uplink signals from UE 120. In some embodiments, the DL PRS may be for the 3GPP LTE radio access type. In embodiments where the DL PRS may be for the 3GPP LTE radio access type, the TPC 140 may include functionality for a 3GPP evolved NodeB (eNB) or a 3GPP Home eNB.

In some embodiments, the signaling information may comprise PRS configuration parameters for the TP 110, an identity of the TP 110, a location of the TP 110, or a combination thereof. Further, exchanging the signaling information with the TPC 140 may comprise receiving the signaling information from the TPC 140, wherein the received signaling information may comprise information obtained from an Operations and Maintenance (O&M) server (e.g. O&M 195).

In some embodiments, exchanging the signaling information with TPC 140 may comprise receiving the signaling information from TPC 140, wherein the signaling information comprises a common time reference. The common time reference may be a time reference for one of: the Global Positioning System (GPS), or a Coordinated Universal Time (UTC), or a Global Navigation Satellite System (GNSS), and TP 110 may further synchronize the broadcast of the DL PRS to the common time reference.

In some embodiments, the TP 110 may be communicatively coupled to the TPC 140 using a local area network (LAN) or a wireless LAN (WLAN) (e.g. via transceiver 810 and/or communications interface 890).

The methodologies described herein in flow charts and message flows may be implemented by various means depending upon the application. For example, these methodologies may be implemented in hardware, firmware, software, or any combination thereof. For a hardware implementation, the processor(s) 802 and/or PRS generation component 816 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with micro-code, procedures, functions, and so on that perform the functions described herein. Any machine-readable medium tangibly embodying instructions may be used in implementing the methodologies described herein. For example, software may be stored in memory storage 854, which may support the use of non-transitory computer-readable media including removable media. Program code may be resident on non-transitory computer readable media and/or memory/storage 854 and may be read and executed by processor(s) 802.

Memory may be implemented within processor(s) 802 or external to processor(s) 802. As used herein the term “memory” refers to any type of long term, short term, volatile, nonvolatile, or other memory and is not to be limited to any particular type of memory or number of memories, or type of media upon which memory is stored. For example, memory/storage 854, which may include non-transitory computer-readable media, may include program code to receive PRS configuration information and/or to generate PRS for transmission in a manner consistent with disclosed embodiments. In addition, TP 110 may receive wired, wireless, or network signals indicative of instructions and data. The instructions and data may be configured to cause processor(s) 802 to implement PRS configuration and/or PRS transmission.

Memory/storage 854 may represent any data storage mechanism. Memory/storage 854 may include, for example, a primary memory and/or a secondary memory. Primary memory may include, for example, a random access memory, read only memory, non-volatile RAM, etc. While illustrated in this example as being separate from processor(s) 802, it should be understood that all or part of a primary memory may be provided within or otherwise co-locatedcoupled with processor(s) 802. Secondary memory may include, for example, the same or similar type of memory as primary memory and/or storage such as hard disk drives, optical disc drives, tape drives, a solid state memory drive, etc.

In certain implementations, secondary memory may be operatively receptive of, or otherwise configurable to couple to a non-transitory computer-readable medium. As such, in certain example implementations, the methods and/or apparatuses presented herein may take the form in whole or part of a removable media drive that may include non-transitory computer readable medium with computer implementable instructions stored thereon, which if executed by at least one processor(s) 802 may be operatively enabled to perform all or portions of the example operations as described herein.

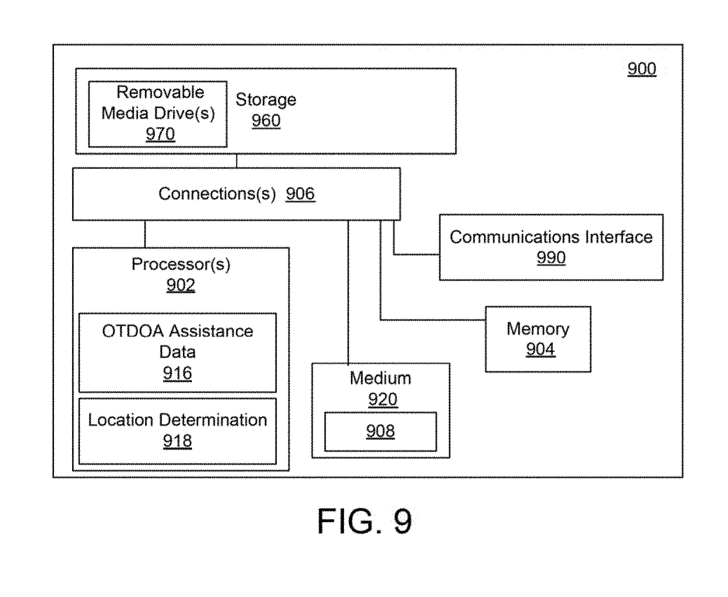

Reference is now made to FIG. 9, which is a schematic block diagram illustrating a location server (LS) 900. Location server 900 may correspond to a SUPL SLP or to an E-SMLC such as E-SMLC 155 in system 100. In some embodiments, location server 900 may perform some or all of the methods and techniques described herein associated with FIGS. 1-6B.

In some embodiments, location server 900 may include, for example, one or more processor(s) 902, memory 904, storage 960, and communications interface 990 (e.g., a wireline and/or wireless network interface) and computer-readable medium 920, which may be operatively coupled with one or more connections 906 (e.g., buses, lines, fibers, links, etc.). In certain example implementations, some portion of location server 900 may take the form of a chipset, and/or the like.

Communications interface 990 may include a variety of wired and wireless connections that support wired transmission and/or reception and, if desired, may additionally or alternatively support transmission and reception of one or more signals over one or more types of wireless and/or wireline communication networks. Communications interface 990 may also include interfaces for communication with various other computers and peripherals. For example, in one embodiment, Communications interface 990 may comprise network interface cards, input-output cards, chips and/or ASICs that implement one or more of the communication functions performed by location server 900. In some embodiments, communications interface 990 may also interface with cellular network entities to obtain or provide a variety of network configuration related information, such as information for TPs 110, Location Requests for UEs 120, OTDOA assistance information for UEs 120. The information may be obtained from and/or sent to UEs 120, TPCs 140 and/or other network entities.

Communications interface 990 may make use of the LPPa protocol defined in 3GPP TS 36.455 or a modification of this protocol to obtain (or provide) PRS configuration information, timing and/or other information from (or to) a TPC 140. The information may also be sent to a UE 120 using the LPP or LPP/LPPe protocol. Processor(s) 902 may request and receive PRS configuration information for TPs 110 and location information for TPs 110 using LPPa from a TPC 140. Further, processor(s) 902 may use some or all of the information (e.g.) to generate OTDOA assistance data for UEs 120, which may be transmitted using LPP or LPP/LPPe in a manner consistent with disclosed embodiments.

Processor(s) 902 may be implemented using a combination of hardware, firmware, and software. In some embodiments, processor(s) 902 may generate OTDOA assistance information for UEs 120, compute the location of a UE 120 based on OTDOA RSTD measurements obtained and provided by UE 120, etc. In some embodiments, processor(s) 902 may generate the OTDOA assistance information as Long Term Evolution (LTE) Positioning Protocol (LPP) or LPP extensions (LPPe) messages. In some embodiments, processor(s) 902 may represent one or more circuits configurable to perform at least a portion of a data signal computing procedure or process related to the operation of location server 900.

In some embodiments, LS 900 and/or one or more of: processor 902, OTDOA Assistance Data component 916, or Location Determination component 918 may determine a location of a UE 120 as outlined further below. For example, LS 900 and/or processor 902 may exchange a first signaling information with a TPC 140 (e.g. using communications interface 990), where the TPC may control at least one PRS TP, where the PRS TP broadcasts a downlink (DL) Positioning Reference Signal (PRS), based at least in part on the first signaling information, to the UE 120. As outlined previously, PRS TPs may refrain from broadcasting information to UE 120 indicating support for uplink signals from UE 120. In some embodiments, the first signaling information may comprise PRS configuration parameters for the at least one PRS TP, an identity of the at least one PRS TP, a location of the at least one PRS TP, or some combination thereof. In some embodiments, exchanging a first signaling information with a Transmission Point Controller (TPC) 140 may comprise receiving the first signaling information from the TPC 140. In some embodiments, the DL PRS may be for the 3GPP LTE radio access type. Further, in some embodiments, the first signaling information may be exchanged using the 3GPP LTE Positioning Protocol A (LPPa). Further, in embodiments where the DL PRS may be for the 3GPP LTE radio access type, the TPC 140 may include functionality for a 3GPP evolved NodeB (eNB) or a 3GPP Home eNB.

Further, in some embodiments, LS 900 and/or processor 902 may send a second signaling information to UE 120 (e.g. using communications interface 990), where the second signaling information may comprise a portion of the first signaling information. Further, LS 900 and/or processor 902 may receive a third signaling information from the UE (e.g. using communications interface 990), where the third signaling information may be based on the second signaling information. In embodiments where the DL PRS may be for the 3GPP LTE radio access type, the second signaling information may be sent and the third signaling information may be received using the 3GPP LTE Positioning Protocol (LPP). For example, the second signaling information may comprise an LPP Provide Assistance Data message, and the third signaling information may comprise an LPP Provide Location Information message.

A location of UE 120 may then be determined by the LS 900 (e.g. by processor(s) 902 or location determination component 918) based on the first signaling information and the third signaling information. In embodiments where the DL PRS may be for the 3GPP LTE radio access type, the second signaling information may comprise an LPP Provide Assistance Data message, the third signaling information may comprise an LPP Provide Location Information message, and/or the location of the UE may be determined based on the 3GPP observed time difference of arrival (OTDOA) position method.

The methodologies described herein in flow charts and message flows may be implemented by various means depending upon the application. For example, these methodologies may be implemented in hardware, firmware, software, or any combination thereof. For a hardware implementation, the processor(s) 902 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with microcode, procedures, functions, and so on that perform the functions described herein. Any machine-readable medium tangibly embodying instructions may be used in implementing the methodologies described herein. For example, software may be stored in storage 960 and/or on removable media drive 970, which may support the use of non-transitory computer-readable media. Program code 908 may be resident on non-transitory computer readable media 920 or memory 904 and may be read and executed by processor(s) 902. Memory may be implemented within processor(s) 902 or external to processor(s) 902. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code 908 on a non-transitory computer-readable medium 920 and/or memory 904. Examples include computer-readable media encoded with a data structure and computer-readable media encoded with a computer program. For example, non-transitory computer-readable medium 920 including program code 908 stored thereon may include program code to support LPPa, LPP, PRS configuration information processing, generation of OTDOA assistance information, location determination based on RSTD measurements, and interfacing with one or more network entities in a manner consistent with disclosed embodiments.

Non-transitory computer-readable media 920 includes a variety of physical computer storage media. A storage medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer, disk and disc, as used herein, includes compact disc (CD), laser disc, optical disc, digital versatile disc (DVD), floppy disk and Blu-ray disc where disks usually reproduce data magnetically, while discs reproduce data optically with lasers. Other embodiments of non-transitory computer readable media include flash drives, USB drives, solid state drives, memory cards, etc. Combinations of the above should also be included within the scope of computer-readable media.

Memory 904 may represent any data storage mechanism. Memory 904 may include, for example, a primary memory and/or a secondary memory. Primary memory may include, for example, a random access memory, read only memory, non-volatile RAM, etc. While illustrated in this example as being separate from processor(s) 902, it should be understood that all or part of a primary memory may be provided within or otherwise co-located/coupled with processor(s) 902. Secondary memory may include, for example, the same or similar type of memory as primary memory and/or storage 960 such as hard disk drives, optical disc drives, tape drives, a solid state memory drive, etc. In some embodiments, storage 960 may comprise one or more databases that may hold information pertaining to various entities in system 100 (e.g. eNB 104, TPCs 140, TPs 110) and/or the broader cellular network. In some embodiments, information in the databases may be read, used, and/or updated by processor(s) 902 during various computations, including storing capabilities of UE 120, capabilities of location server 900, generating OTDOA assistance data, computing a location of UE 120, etc.

In certain implementations, secondary memory may be operatively receptive of, or otherwise configurable to couple to a non-transitory computer-readable medium 920. As such, in certain example implementations, the methods and/or apparatuses presented herein may take the form in whole or part of a removable media drive 970 that may include non-transitory computer readable medium with computer implementable instructions stored thereon, which if executed by at least one processor(s) 902 may be operatively enabled to perform all or portions of the example operations as described herein. Computer readable medium 920 may also be a part of memory 904.

Although the present disclosure is described in connection with specific embodiments for instructional purposes, the disclosure is not limited thereto. Various adaptations and modifications may be made to the disclosure without departing from the scope. Therefore, the spirit and scope of the appended claims should not be limited to the foregoing description.

What is claimed is:

1. A method on a Transmission Point Controller (TPC) to facilitate User Equipment (UE) location determination, the method comprising:
exchanging a first signaling information with a Positioning Reference Signal Transmission Point (PRS TP) broadcasting a downlink (DL) positioning reference signal (PRS) to the UE, wherein the PRS TP is controlled by the TPC and the broadcasting is based at least in part on the first signaling information; and
exchanging a second signaling information with a location server, wherein the second signaling information comprises at least a portion of the first signaling information.

2. The method of claim 1, wherein exchanging the first signaling information comprises:
sending the first signaling information to the PRS TP, wherein the first signaling information comprises a common time reference.

3. The method of claim 2, wherein sending the first signaling information to the PRS TP comprises:
determining the common time reference based on input from a GPS receiver or a GNSS receiver coupled to the TPC, wherein the common time reference is a time reference for one of: a Global Positioning System (GPS), or a Coordinated Universal Time (UTC), or a Global Navigation Satellite System (GNSS).

4. The method of claim 1, wherein the first signaling information and the second signaling information each comprise PRS configuration parameters for the PRS TP, an identity of the PRS TP, a location of the PRS TP, or some combination thereof.

5. The method of claim 1, wherein the DL PRS is for the 3rd Generation Partnership Project (3GPP) Long Term Evolution radio access type.

6. The method of claim 5, wherein the second signaling information is exchanged using the 3GPP LTE Positioning Protocol A (LPPa).

7. The method of claim 6, wherein the TPC includes functionality for a 3GPP evolved NodeB (eNB) or a 3GPP Home eNB.

8. A Transmission Point Controller (TPC) comprising:
a memory, and
a processor coupled to the memory, wherein the processor is configured to:
exchange a first signaling information with a Positioning Reference Signal Transmission Point (PRS TP) broadcasting a downlink (DL) positioning reference signal (PRS) to a UE, wherein the PRS TP is controlled by the TPC and the broadcasting is based at least in part on the first signaling information; and
exchange a second signaling information with a location server, wherein the second signaling information comprises at least a portion of the first signaling information.

9. The TPC of claim 8, wherein to exchange the first signaling information, the processor is configured to:
send the first signaling information to the PRS TP, wherein the first signaling information comprises a common time reference.

10. The TPC of claim 9, wherein to send the first signaling information to the PRS TP, the processor is configured to:
determine the common time reference based on input from a GPS receiver or a GNSS receiver coupled to the TPC, wherein the common time reference is a time reference for one of: a Global Positioning System (GPS), or a Coordinated Universal Time (UTC), or a Global Navigation Satellite System (GNSS).

11. The TPC of claim 8, wherein the first signaling information and the second signaling information each comprise PRS configuration parameters for the PRS TP, an identity of the PRS TP, a location of the PRS TP, or some combination thereof.

12. The TPC of claim 8, wherein the DL PRS is for the 3rd Generation Partnership Project (3GPP) Long Term Evolution radio access type.

13. The TPC of claim 12, wherein the second signaling information is exchanged using the 3GPP LTE Positioning Protocol A (LPPa).

14. The TPC of claim 13, wherein the TPC includes functionality for a 3GPP evolved NodeB (eNB) or a 3GPP Home eNB.

15. A Transmission Point (TP) comprising:
a network interface comprising a transceiver,
a processor coupled to the network interface, wherein the processor is configured to:
perform, via the network interface, exchange of a signaling information with a Transmission Point Controller (TPC);
initiate via the transceiver, a broadcast of a downlink (DL) positioning reference signal (PRS) to the UE, wherein the broadcast of the DL PRS is based, at least in part, on the signaling information; and
configure the transceiver to refrain from broadcasting information to the UE indicating support for uplink signals from the UE.

16. The TP of claim 15, wherein to exchange the signaling information with the TPC, the processor is configured to:
receive, via the network interface, the signaling information from the TPC, wherein the signaling information comprises a common time reference.

17. The TP of claim 16, wherein:
the common time reference is a time reference for one of: a Global Positioning System (GPS), or a Coordinated Universal Time (UTC), or a Global Navigation Satellite System (GNSS), and
wherein, to initiate the broadcast of the DL PRS, the processor is configured to:
synchronize the broadcast of the DL PRS to the common time reference.

18. The TP of claim 15, wherein the signaling information comprises PRS configuration parameters for the TP, an identity of the TP, a location of the TP, or a combination thereof.

19. The TP of claim 15, wherein the DL PRS is for the 3^{rd} Generation Partnership Project (3GPP) Long Term Evolution radio access type.

20. The TP of claim 19, wherein the TPC includes functionality for a 3GPP evolved NodeB (eNB) or a 3GPP Home eNB.

21. The TP of claim 15, wherein the TP is coupled to the TPC using a Local Area Network (LAN) coupled to a wired communications interface, or a Wireless LAN (WLAN) coupled to the transceiver.

22. A location server comprising:
a memory, and
a processor coupled to the memory, wherein the processor is configured to:
exchange a first signaling information with a Transmission Point Controller (TPC) controlling at least one Positioning Reference Signal Transmission Point (PRS TP), wherein the first signaling information comprises information defining aspects of downlink (DL) PRS broadcasting by the PRS TP;
sending a second signaling information to a User Equipment (UE), the second signaling information comprising a portion of the first signaling information;
receiving a third signaling information from the UE, the third signaling information based on the second signaling information; and
determining a location of the UE based, at least in part, on the first signaling information and the third signaling information.

23. The location server of claim 22, wherein the first signaling information comprises PRS configuration parameters for the at least one PRS TP, an identity of the at least one PRS TP, a location of the at least one PRS TP, or some combination thereof.

24. The location server of claim 23, wherein exchanging the first signaling information with a Transmission Point Controller (TPC) comprises:
receiving the first signaling information from the TPC.

25. The location server of claim 22, wherein the first signaling information is exchanged using the 3GPP LTE Positioning Protocol A (LPPa).

26. The location server of claim 25, wherein the location server is an enhanced serving mobile location center (E-SMLC).

27. The location server of claim 25, wherein the TPC includes functionality for a 3GPP evolved NodeB (eNB) or a 3GPP Home eNB.

28. The location server of claim 25, wherein the second signaling information is sent, and the third signaling information is received using the 3GPP LTE Positioning Protocol (LPP).

29. The location server of claim 28, wherein:
the second signaling information comprises an LPP Provide Assistance Data message, and the third signaling information comprises an LPP Provide Location Information message, and wherein
determining the location of the UE comprises:
determining the location of the UE based at least in part on the 3GPP observed time difference of arrival (OTDOA) position method.
